(19) United States
(12) Patent Application Publication
(10) Pub. No.: US 2013/0021500 A1
(43) Pub. Date: Jan. 24, 2013

(54) OPTICAL DEVICE

(71) Applicants: Susumu Ozeki, Shijonawate-shi (JP); Kei Tanimura, Kawanishi-shi (JP); Tetsuya Nakao, Kyotanabe-shi (JP); Yukinobu Nishikawa, Daito-shi (JP)

(72) Inventors: Susumu Ozeki, Shijonawate-shi (JP); Kei Tanimura, Kawanishi-shi (JP); Tetsuya Nakao, Kyotanabe-shi (JP); Yukinobu Nishikawa, Daito-shi (JP)

(73) Assignee: SANYO ELECTRIC CO., LTD., Osaka (JP)

(21) Appl. No.: 13/553,365

(22) Filed: Jul. 19, 2012

(30) Foreign Application Priority Data
Jul. 22, 2011 (JP) 2011-161280
Jul. 27, 2011 (JP) 2011-164560

(51) Int. Cl. G02B 13/00; H04N 5/225

(52) U.S. Cl. 348/240.3; 348/335; 348/E05.024

(57) ABSTRACT

An optical device includes a rotary member. A rotary member is rotated across a first angle range and a second angle range lined up in a direction in which an angle is increased. An activator activates a power source when a rotation angle of the rotary member is increased to a first specific angle belonging to the first angle range. An adjuster adjusts a setting of an optical system with reference to a rotation of the rotary member in the second angle range. A notifier generates a notification when the rotation angle of the rotary member remains within the first angle range in a state where the power source is activated.

### CROSS REFERENCE OF RELATED APPLICATION

The disclosure of Japanese Patent Application No. 2011-161280, which was filed on Jul. 22, 2011, and the disclosure of Japanese Patent Application No. 2011-164560, which was filed on Jul. 27, 2011 are incorporated herein by reference.

### BACKGROUND OF THE INVENTION

1. Field of the Invention

The present invention relates to an optical device, and in particular, relates to an optical device which is applied to a digital camera and adjusts a setting of an optical system with reference to a rotation of a rotary member.

2. Description of the Related Art

According to one example of this type of device, when a zoom switch which instructs a zoom is depressed, a main microcomputer instructs a camera AF microcomputer to zoom in a wide direction. The camera AF microcomputer drives a zoom lens arranged in a video lens unit, in the wide direction. A zoom position is detected by a zoom position detecting block, and a detection result is transmitted to the main microcomputer via the camera AF microcomputer. When the zoom position has reached a wide end, the main microcomputer drives a display signal generating block so as to display character strings indicating the “wide end” on an electronic viewfinder.

However, in the above-described device, the zoom switch is independent of a power switch, and therefore, operability is limited.

### SUMMARY OF THE INVENTION

An optical device according to the present invention comprises: a rotary member which is rotated across a first angle range and a second angle range lined up in a direction in which an angle is increased; an activator which activates a power source when a rotation angle of the rotary member is increased to a first specific angle belonging to the first angle range; an adjuster which adjusts a setting of an optical system with reference to a rotation of the rotary member in the second angle range; and a notifier which generates a notification when the rotation angle of the rotary member remains within the first angle range in a state where the power source is activated.

According to the present invention, an operation control program recorded on a non-transitory recording medium in order to control an optical device provided with a rotary member which is rotated across a first angle range and a second angle range lined up in a direction in which an angle is increased, and an adjuster which adjusts a setting of an optical system with reference to a rotation of the rotary member in the second angle range, the program causing a processor of the optical device to perform the steps comprises: an activating step of activating a power source when a rotation angle of the rotary member is increased to a first specific angle belonging to the first angle range; and a notifying step of generating a notification when the rotation angle of the rotary member remains within the first angle range in a state where the power source is activated.

According to the present invention, an operation control method executed by an optical device provided with a rotary member which is rotated across a first angle range and a second angle range lined up in a direction in which an angle is increased, and an adjuster which adjusts a setting of an optical system with reference to a rotation of the rotary member in the second angle range, comprises: an activating step of activating a power source when a rotation angle of the rotary member is increased to a first specific angle belonging to the first angle range; and a notifying step of generating a notification when the rotation angle of the rotary member remains within the first angle range in a state where the power source is activated.

An optical device according to the present invention comprises: a rotary member which is rotated across a first angle range and a second angle range lined up in a direction in which an angle is increased; an activator which activates a power source when a rotation angle of the rotary member is increased to a first specific angle belonging to the first angle range; an adjuster which adjusts a setting of an optical system with reference to a rotation of the rotary member in the second angle range; a stopper which stops the power source when the rotation angle of the rotary member is decreased to a second specific angle belonging to the first angle range; a notifier which intermittently generates a notification in a partial period during which the rotation angle of the rotary member remains within the first angle range, among periods from an activation by the activator to a stop by the stopper; and a power-source controller which stops/restarts the power source corresponding to suspending/restarting the notification generated by the notifier.

According to the present invention, an operation control program recorded on a non-transitory recording medium in order to control an optical device provided with a rotary member which is rotated across a first angle range and a second angle range lined up in a direction in which an angle is increased and an adjuster which adjusts a setting of an optical system with reference to a rotation of the rotary member in the second angle range, the program causing a processor of the optical device to perform the steps comprises: an activating step of activating a power source when a rotation angle of the rotary member is increased to a first specific angle belonging to the first angle range; a stopping step of stopping the power source when the rotation angle of the rotary member is decreased to a second specific angle belonging to the first angle range; a notifying step of intermittently generating a notification in a partial period during which the rotation angle of the rotary member remains within the first angle range, among periods from an activation by the activating step to a stop by the stopping step; and a power-source controlling step of stopping/restarting the power source corresponding to suspending/restarting the notification generated by the notifying step.

According to the present invention, an operation control method executed by an optical device provided with a rotary member which is rotated across a first angle range and a second angle range lined up in a direction in which an angle is increased and an adjuster which adjusts a setting of an optical system with reference to a rotation of the rotary member in the second angle range, comprises: an activating step of activating a power source when a rotation angle of the rotary member is increased to a first specific angle belonging to the first angle range; a stopping step of stopping the power source when the rotation angle of the rotary member is decreased to a second specific angle belonging to the first angle range; a notifying step of intermittently generating a notification in a partial period during which the rotation angle of the rotary member remains within the first angle range, among periods from an activation by the activating step to a stop by the stopping step; and a power-source controlling step of stopping/restarting the power source corresponding to suspending/restarting the notification generated by the notifying step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one portion of rotation behavior of a ring applied to the embodiment in FIG. 2;

FIG. 4 is an illustrative view showing another portion of rotation behavior of the ring applied to the embodiment in FIG. 2;

FIG. 5 is an illustrative view showing one example of a configuration of a power-source and zoom control unit applied to the embodiment in FIG. 2;

FIG. 6 (A) is an illustrative view showing one example of a start screen;

FIG. 6 (B) is an illustrative view showing one example of an ending screen;

FIG. 7 (A) is an illustrative view showing one example of an activating-operation guide screen;

FIG. 7 (B) is an illustrative view showing one example of an end-operation guide screen;

FIG. 8 is a graph showing one example of a tracking curve;

FIG. 9 is a flowchart showing one portion of behavior of a sub CPU applied to the embodiment in FIG. 2;

FIG. 10 is a flowchart showing one portion of behavior of a main CPU applied to the embodiment in FIG. 2;

FIG. 11 is a flowchart showing another portion of behavior of the main CPU applied to the embodiment in FIG. 2;

FIG. 12 is a flowchart showing still another portion of behavior of the main CPU applied to the embodiment in FIG. 2;

FIG. 13 is a flowchart showing yet another portion of behavior of the main CPU applied to the embodiment in FIG. 2;

FIG. 14 is a block diagram showing a basic configuration of one embodiment of the present invention;

FIG. 15 is a block diagram showing a configuration of one embodiment of the present invention;

FIG. 16 is an illustrative view showing one portion of rotation behavior of a ring applied to the embodiment in FIG. 15;

FIG. 17 is an illustrative view showing another portion of rotation behavior of a ring applied to the embodiment in FIG. 15;

FIG. 18 is an illustrative view showing one example of a configuration of a power-source and zoom control unit applied to the embodiment in FIG. 15;

FIG. 19 (A) is an illustrative view showing one example of a start screen;

FIG. 19 (B) is an illustrative view showing one example of an ending screen;

FIG. 20 (A) is an illustrative view showing one example of a start-operation guide screen;

FIG. 20 (B) is an illustrative view showing one example of an end-operation guide screen;

FIG. 21(A) is a timing chart showing one example of display/hiding behavior of the start-operation guide screen;

FIG. 21 (B) is a timing chart showing one example of behavior of turning on/off a main power source;

FIG. 22 is a graph showing one example of a tracking curve;

FIG. 23 (A) is a timing chart showing one example of display/hiding behavior of the end-operation guide screen;

FIG. 23 (B) is a timing chart showing one example of behavior of turning on/off the main power source;

FIG. 24 is a flowchart showing one portion of behavior of a sub CPU applied to the embodiment in FIG. 15;

FIG. 25 is a flowchart showing another portion of behavior of the sub CPU applied to the embodiment in FIG. 15;

FIG. 26 is a flowchart showing one portion of behavior of a main CPU applied to the embodiment in FIG. 15;

FIG. 27 is a flowchart showing another portion of behavior of the main CPU applied to the embodiment in FIG. 15;

FIG. 28 is a flowchart showing still another portion of behavior of the main CPU applied to the embodiment in FIG. 15;

FIG. 28 is a flowchart showing yet another portion of behavior of the main CPU applied to the embodiment in FIG. 15;

FIG. 30 is a flowchart showing another portion of behavior of the main CPU applied to the embodiment in FIG. 15;

FIG. 31 is a flowchart showing still another portion of behavior of the main CPU applied to the embodiment in FIG. 15; and

FIG. 32 is a flowchart showing yet another portion of behavior of the main CPU applied to the embodiment in FIG. 15.

### DETAILED DESCRIPTION OF THE PREFERRED EMBODIMENTS

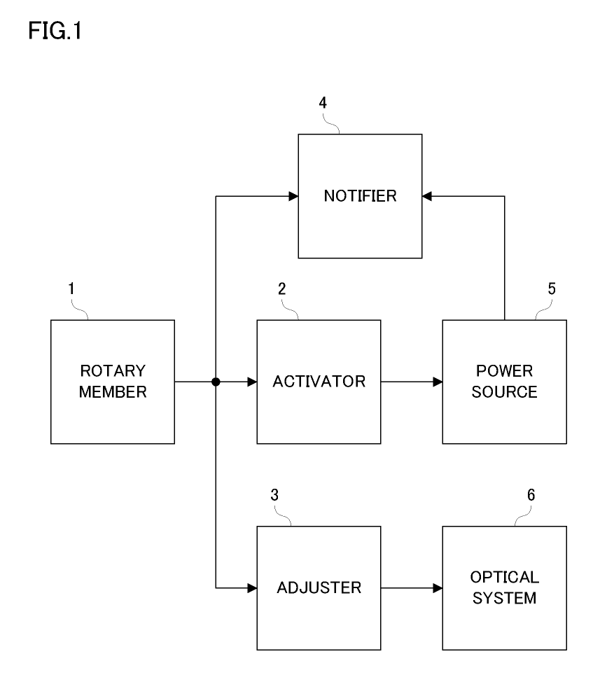

With reference to FIG. 1, an optical device according to one embodiment of the present invention is basically configured as follows: A rotary member 1 is rotated across a first angle range and a second angle range lined up in a direction in which an angle is increased. An activator 2 activates a power source 5 when a rotation angle of the rotary member 1 is increased to a first specific angle belonging to the first angle range. An adjuster 3 adjusts a setting of an optical system 6 with reference to a rotation of the rotary member 1 in the second angle range. A notifier 4 generates a notification when the rotation angle of the rotary member 1 remains within the first angle range in a state where the power source 5 is activated.

The power source 5 is activated when the rotation angle of the rotary member 1 is increased to the first specific angle belonging to the first angle range, and the setting of the optical system 6 is adjusted with reference to the rotation of the rotary member 1 in the second angle range lined up in the first angle range. Thereby, it becomes possible to control the power source 5 and the setting of the optical system 6 by a single member, and therefore, an operability is improved. Moreover, when the rotation angle of the rotary member 1 remains within the first angle range in spite of the power source 5 having been activated, the notification is generated. An operator is capable of recognizing by the notification, that a current state is an activated state, and thereby, a consumed power is inhibited.

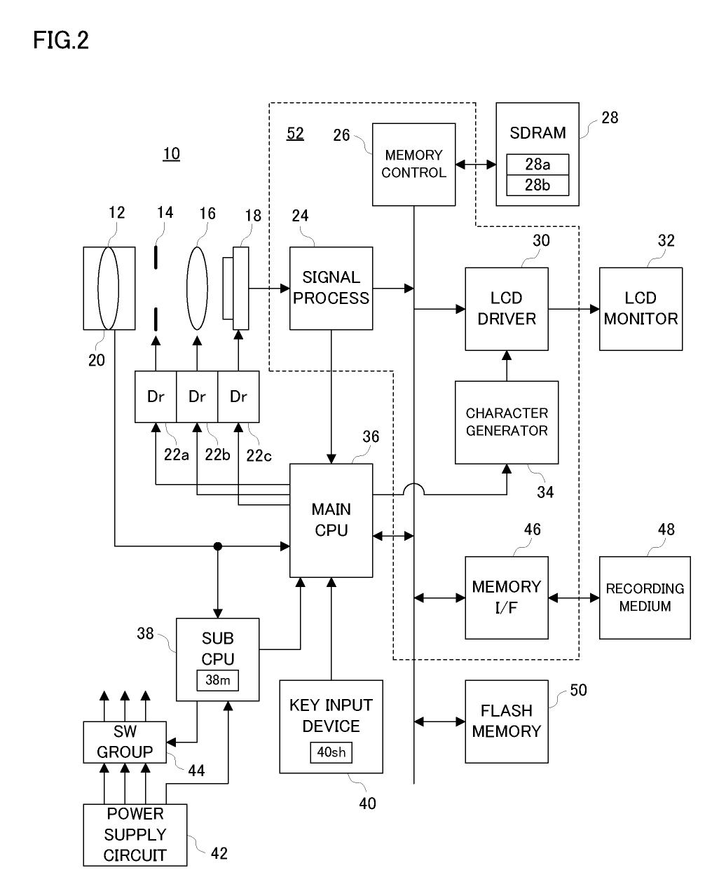

With reference to FIG. 2, a digital camera 10 according to this embodiment includes a power supply circuit 42. The power supply circuit 42 generates a plurality of direct current power supplies, each of which shows a different voltage value. One portion of the plurality of generated direct current power supplies is directly applied to a sub CPU 38, and another portion of the plurality of generated direct current power supplies is applied to circuits other than the sub CPU 38 via a switch group 44. Therefore, the sub CPU 38 is activated all the times, whereas the circuits other than the sub CPU 38 are activated/stopped in response to turning on/off of the switch group 44.

It is noted that a state where the circuits other than the sub CPU 38 are activated is defined as a “main-power-source on state”, and a state where the circuits other than the sub CPU 38 are stopped is defined as a “main-power-source off state”.

Moreover, the digital camera 10 includes a zoom lens 12 driven by a power-source and zoom control unit 20, and an aperture unit 14 and a focus lens 16 driven by drivers 22a and 22b, respectively. An optical image that underwent these components enters, with irradiation, an imaging surface of an imager 18, and is subjected to a photoelectric conversion.

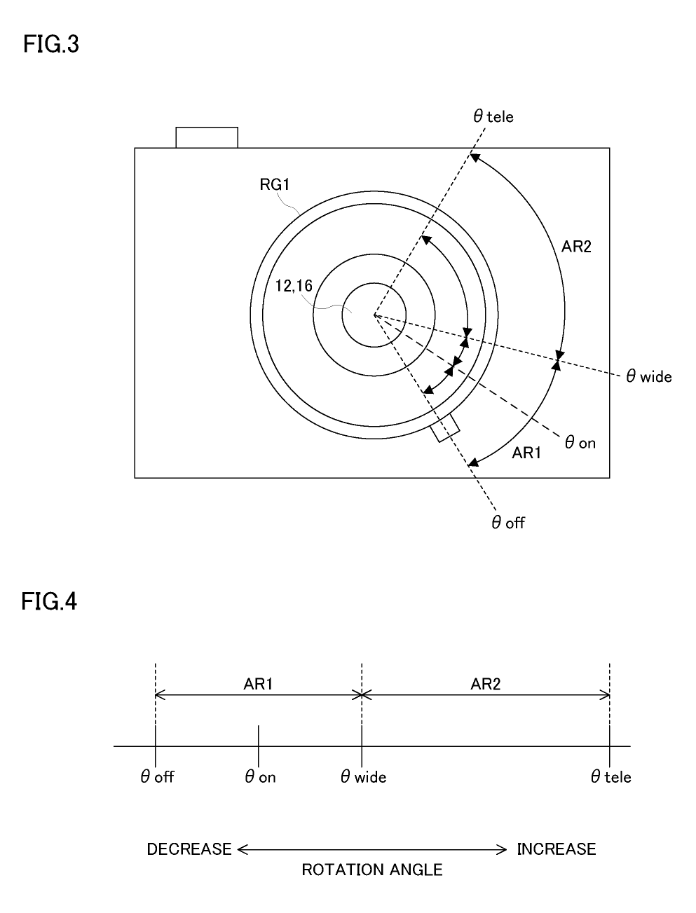

With reference to FIG. 3 to FIG. 5, the power-source and zoom control unit 20 is arranged on a front surface of a camera housing CB1 in a manner to surround the zoom lens 12, and has a ring RG1 capable of being rotated in a direction around an optical axis AX1 extending in a direction orthogonal to the imaging surface. The ring RG1 is capable of being rotated in a range from θoff to θtele, and this rotatable range is divided into angle ranges AR1 and AR2 lined up in a direction in which an angle is increased.

A lower limit angle and an upper limit angle of the angle range AR1 are respectively equivalent to “θoff” and “θwide”, and a lower limit angle and an upper limit angle of the angle range AR2 are respectively equivalent to “θwide” and “θtele”. Moreover, “θon” is assigned near a center of the angle range AR1.

In the angle range AR1, when a rotation angle of the ring RG1 is increased from “θoff” to “θon”, the sub CPU 38 turns on the switch group 44 in order to transition to the main-power-source on state, and furthermore, initializes a setting of an ASIC 52.

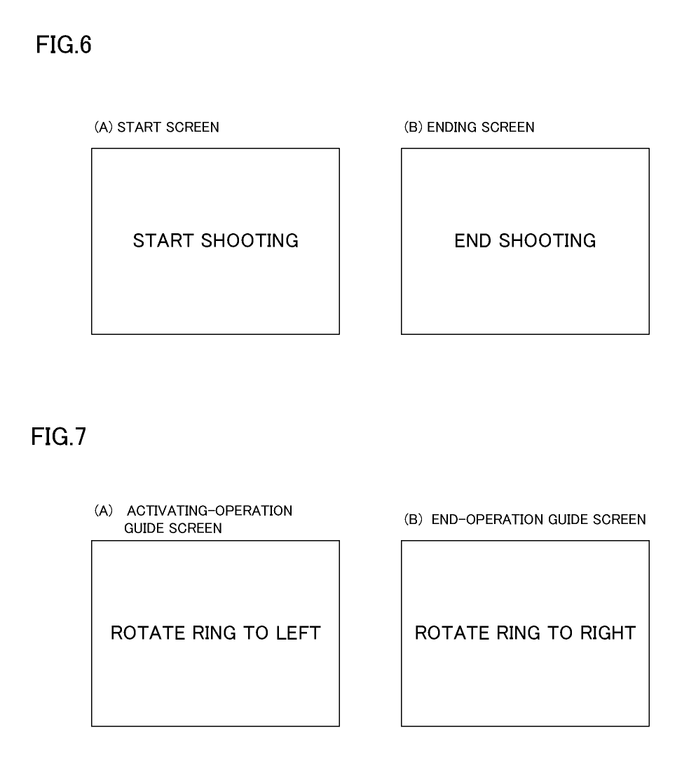

Firstly, an activated main CPU 36 applies a command to a character generator 34 under a power-source control task, in order to display a start screen shown in FIG. 6 (A) for a predetermined time period (=10 seconds) on an LCD monitor 32. The character generator 34 outputs character data according to the command, and an LCD driver 30 drives the LCD monitor 32 based on the outputted character data. As a result, the start screen is displayed on the LCD monitor 32 for the predetermined time period.

When a period during which the rotation angle of the ring RG1 remains within a range from “θon” to “θwide” reaches a threshold value THon (=10 seconds), the main CPU 36 commands the character generator 34 to display an activating-operation guide screen shown in FIG. 7 (A) (a notification screen urging an operation of rotating the ring RG1 to “θwide”). The character generator 34 outputs character data according to the command, and the LCD driver 30 drives the LCD monitor 32 based on the outputted character data. As a result, the activating-operation guide screen is displayed on the LCD monitor 32.

When the rotation angle of the ring RG1 is decreased to “θoff” without reaching “θwide”, the main CPU 36 issues a power-off command toward the sub CPU 38. The sub CPU 38 turns off the switch group 44 in order to transition to the main-power-source off state.

When the rotation angle of the ring RG1 reaches “θwide”, under the power-source control task, the main CPU 36 controls the driver 22b so as to place the focus lens 16 at an initial position. Upon completion of placing, an imaging task is activated by the power-source control task.

It is noted that, when the activating-operation guide screen is displayed on the LCD monitor 32, the main CPU 36 commands the character generator 34 to hide the activating-operation guide screen before initializing a placement of the focus lens 16. The character generator 34 stops outputting the character data, and thereby, the activating-operation guide screen is disappeared.

Under the imaging task activated by the power-source control task, in order to execute a moving-image taking process, the main CPU 36 commands a driver 22c to repeat an exposure procedure and an electric-charge reading-out procedure. In response to a vertical synchronization signal Vsync periodically generated, the driver 22c exposes the imaging surface of the imager 18 and reads out the electric charges produced on the imaging surface in a raster scanning manner. From the imager 18, raw image data that is based on the read-out electric charges is cyclically outputted.

A signal processing circuit 24 performs a white balance adjustment, a color separation and a YUV conversion, on the raw image data outputted from the imager 18. YUV formatted image data produced thereby is written into a YUV image area 28a of an SDRAM 28 through a memory control circuit 26. The LCD driver 30 repeatedly reads out the image data stored in the YUV image area 28a through the memory control circuit 30, and drives the LCD monitor 32 based on the read-out image data. As a result, a real-time moving image (a live view image) representing the scene captured on the imaging surface is displayed on the monitor screen.

Moreover, the signal processing circuit 24 applies Ydata forming the image data to the main CPU 36. The main CPU 36 performs an AE process on the applied Y data so as to calculate an appropriate EV value. An aperture amount and an exposure time period that define the calculated appropriate EV value are respectively set to the drivers 22a and 22c. Thereby, a brightness of a live view image is adjusted approximately.

Moreover, when a predetermined AF start-up condition is satisfied, the main CPU 36 executes a simple AF process based on a high-frequency component of the Y data applied from the signal processing circuit 24. Thereby, the focus lens 16 is placed at a focal point, and as a result, a sharpness of a live view image is improved.

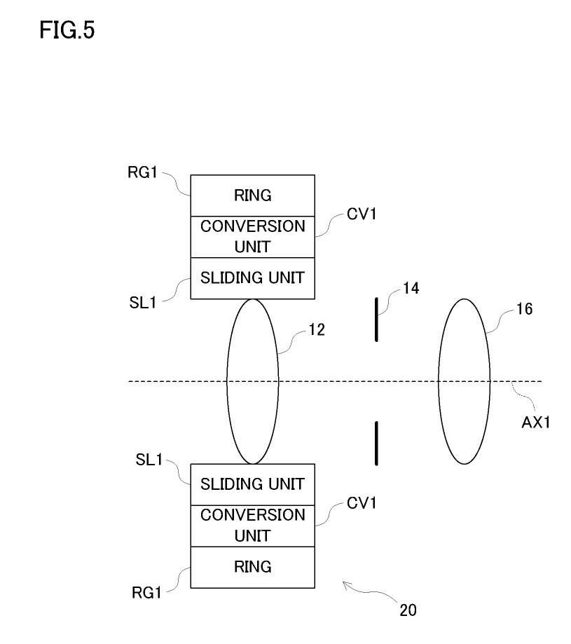

With reference to FIG. 5 again, the power-source and zoom control unit 20 further includes a conversion unit CV1 which converts a rotation movement of the ring RG1 in the angle range AR2 to a linear movement along the optical axis AX1. A sliding unit SL1 slides the zoom lens 12 to a direction along the optical axis AX1 by using the linear movement converted by the conversion unit CV1. The zoom lens 12 is placed at a wide end when the rotation angle indicates “θwide”, and is moved to a tele side along with an increase of the rotation angle in the angle range AR2. Then, the zoom lens 12 is placed at a tele end when the rotation angle indicates “θtele”. A zoom magnification of a live view image changes along with the movement of the focus lens 12.

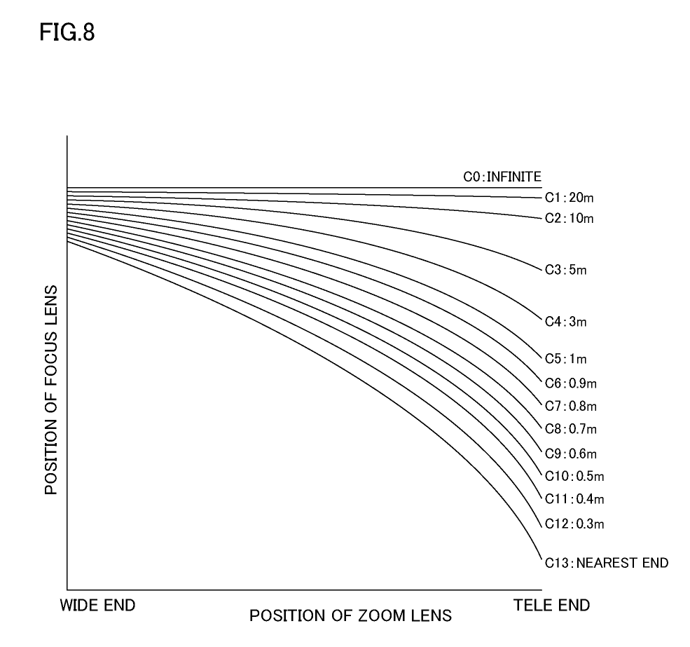

In a flash memory 50, graph data equivalent to tracking curves C0 to C13 shown in FIG. 8 is stored. With reference to FIG. 8, when a depth of field is “infinite”, a focal position changes in a manner to move along the tracking curve C0 relative to a position of the zoom lens 12. Moreover, when the depth of field is “20 m”, the focal position changes in a manner to move along the tracking curve C1 relative to the position of the zoom lens 12. Furthermore, when the depth of field is “10 m”, the focal position changes in a manner to move along the tracking curve C2 relative to the position of the zoom lens 12.

Likewise, when the depths of field are “5 m”, “3 m”, “1 m”, “0.9 m”, “0.8 m”, “0.7 m”, “0.6 m”, “0.5 m”, “0.4 m”, “0.3 m”, and “nearest end”, the focal positions change in a manner to move along the tracking curves C3, C4, C5, C6, C7, C8, C9, C10, C11, C12, and C13 relative to the position of the zoom lens 12, respectively.

Initially when the imaging task is activated, the tracking curve C0 is set as a reference tracking curve. In this regard, coordinates equivalent to current positions of the zoom lens 12 and the focus lens 16 are detected from the graph shown in FIG. 8 at every time the simple AF process is completed. The reference tracking curve is updated to a tracking curve existing on the detected coordinates or a tracking curve created based on two tracking curves sandwiching the detected coordinates.

When the position of the zoom lens 12 is changed by the rotation of the ring RG1, under the power-source control task, the main CPU 36 executes a focus tracking process with reference to the changed position of the zoom lens 12. The focus lens 16 is moved in an optical-axis direction along the reference tracking curve set under the imaging task.

When a shutter button 40sh arranged in a key input device 40 is half depressed, under the imaging task, the main CPU 36 executes a strict AE process that is based on the Y data applied from the signal processing circuit 24 so as to calculate an optimal EV value. Similarly to the above-described case, an aperture amount and an exposure time period that define the calculated optimal EV value are respectively set to the drivers 22a and 22c. As a result, a brightness of a live view image is adjusted strictly.

Moreover, under the imaging task, the main CPU 36 executes a strict AF process that is based on the high-frequency component of the Y data applied from the signal processing circuit 24. Thereby, the focus lens 16 is placed at a focal point, and as a result, a sharpness of a live view image is improved. When the shutter button 40sh is fully depressed, the main CPU 36 executes a still-image taking process, and concurrently, commands a memory I/F 46 to execute a recording process.

Photographed image data representing a scene at a time point at which the shutter button 40sh is fully depressed is evacuated from the YUV image are 28a to a still-image area 28b by the still-image taking process. The memory I/F 46 commanded to execute the recording process reads out the photographed image data evacuated to the still-image area 28b through the memory control circuit 26 so as to record an image file containing the read-out photographed image data on a recording medium 48.

When the rotation angle of the ring RG1 falls below “θwide”, the main CPU 36 applies a command to the character generator 34 under the power-source control task in order to display an ending screen shown in FIG. 6 (B) for only a predetermined time period (=10 seconds), and furthermore, places the focus lens 16 on an evacuation position by controlling the driver 22b. The character generator 34 outputs character data according to the command, and the LCD driver 30 drives the LCD monitor 32 based on the outputted character data. As a result, the ending screen is displayed on the LCD monitor 32 for only the predetermined time period.

When a period during which the rotation angle of the ring RG1 remains within a range from “θwide” to “θoff” reaches a threshold value THoff (=10 seconds), under the power-source control task, the main CPU 36 commands the character generator 34 to display an end-operation guide screen shown in FIG. 7 (B) (a notification screen urging an operation of rotating the ring RG1 to “θoff”). The character generator 34 outputs character data according to the command, and the LCD driver 30 drives the LCD monitor 32 based on the outputted character data. As a result, the end-operation guide screen is displayed on the LCD monitor 32.

When the rotation angle of the ring RG1 reaches “θoff”, the main CPU 36 executes a predetermined ending process, and issues the power-off command toward the sub CPU 38. The sub CPU 38 turns off the switch group 44 in order to transition to the main-power-source off state.

It is noted that, when the end-operation guide screen is displayed on the LCD monitor 32, the main CPU 36 commands the character generator 34 to hide the end-operation guide screen before executing the ending process. The character generator 34 stops outputting the character data, and thereby, the end-operation guide screen is disappeared.

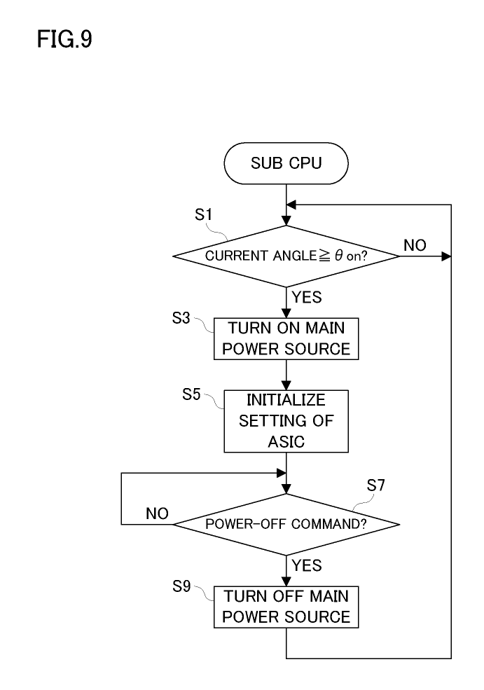

The sub CPU 38 executes a flowchart shown in FIG. 9. It is noted that a control program corresponding to the flowchart is stored in a memory 38m.

In a step S1, it is repeatedly determined whether or not a current rotation angle of the ring RG1 is equal to or more than “θon”. When a determined result is updated from NO to YES, in a step S3, the main power source is turned on (the switch group 44 is turned on), and in a step S5, a setting of the ASIC52 is initialized. In a step S7, it is repeatedly determined whether or not the power-off command is issued from the main CPU 36. When a determined result is updated from NO to YES, in a step S9, the main power source is turned off (the switch group 44 is turned off), and thereafter, the process returns to the step S1.

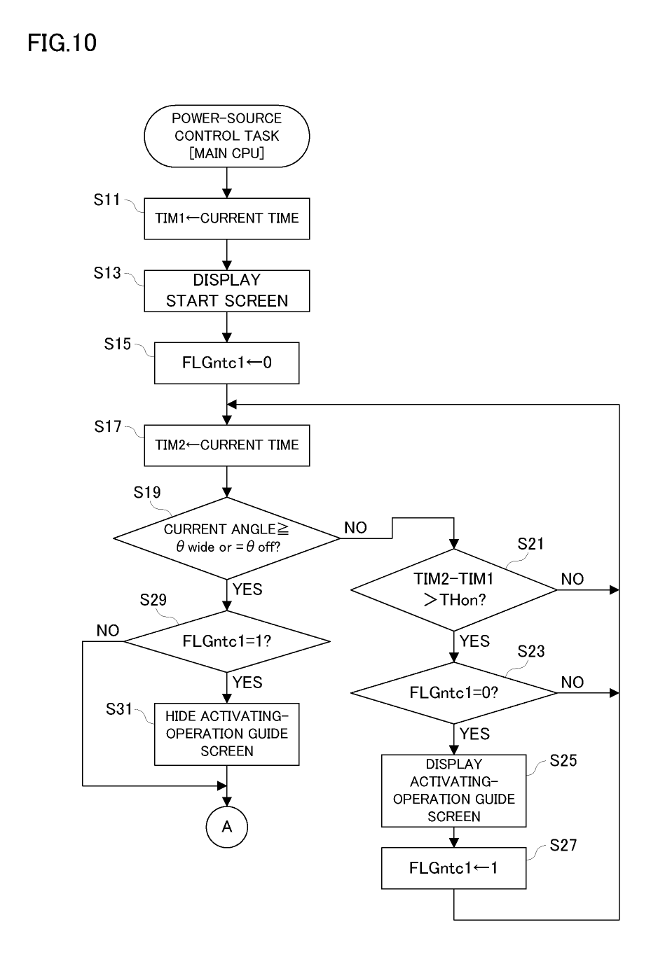

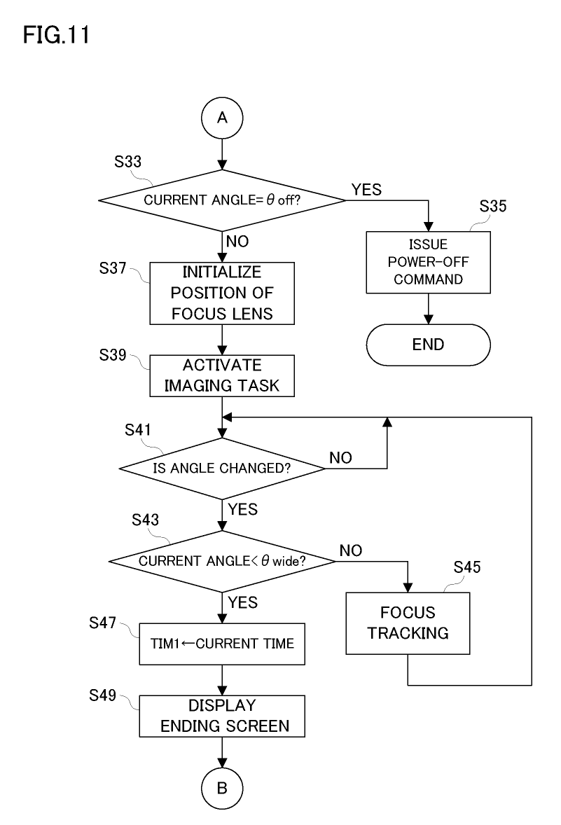

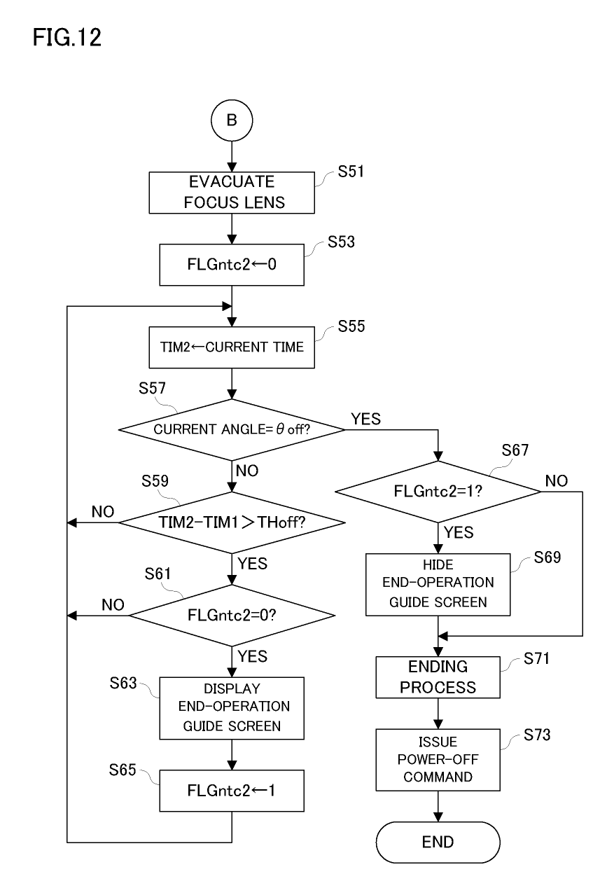

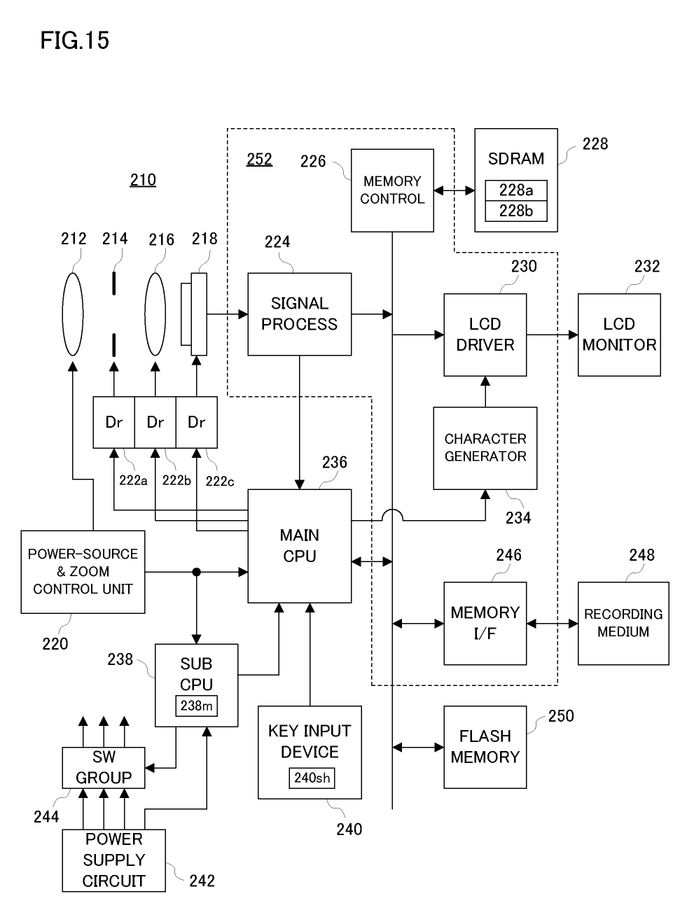

The main CPU 36 executes a plurality of tasks including the power-source control task shown in FIG. 10 to FIG. 13 and the imaging task shown in FIG. 15, in a parallel manner. It is noted that control programs corresponding to these tasks are stored in the flash memory 50.

With reference to FIG. 10, in a step S11, a current time is set to a variable TIM1, and in a step S13, the character generator 34 is commanded to display the start screen for a predetermined time period (=10 seconds). The character generator 34 outputs character data according to the command, and the LCD driver 30 drives the LCD monitor 32 based on the outputted character data. As a result, the start screen is displayed on the LCD monitor 32 for the predetermined time period.

In a step S15, a flag FLGntc1 is set to “0”. Here, the flag FLGntc1 is a flag for identifying display/non-display of the activating-operation guide screen, and “0” indicates a non-display whereas “1” indicates a display. In a step S17, a current time is set to a variable TIM2. In a step S19, it is determined whether or not an OR condition under which a current rotation angle of the ring RG1 is equal to or more than “θwide” or the current rotation angle of the ring RG1 is equivalent to “θoff” is satisfied. When a determined result is NO, the process advances to a step S21, and when the determined result is YES, the process advances to a step S29.

In the step S21, it is determined whether or not a numerical value obtained by subtracting the variable TIM1 from the variable TIM2 exceeds the threshold value THon, and in a step S23, it is determined whether or not the flag FLGntc1 indicates “0”. When at least one of a determined result of the step S21 and a determined result of the step S23 is NO, the process directly returns to the step S17 whereas when both of the determined result of the step S21 and the determined result of the step S23 are YES, the process returns to the step S17 via processes in steps S25 to S27.

In the step S25, the character generator 34 is commanded to display the activating-operation guide screen, and in the step S27, the flag FLGntc1 is updated to “1”. As a result of the process in the step S25, the character generator 34 outputs character data according to the command, and the LCD driver 30 drives the LCD monitor 32 based on the outputted character data. Thereby, the activating-operation guide screen is displayed on the LCD monitor 32.

In the step S29, it is determined whether or not the flag FLGntc1 indicates “1”, and when a determined result is NO, the process directly advances to a step S33 whereas when the determined result is YES, in a step S31, the character generator 34 is commanded to hide the activating-operation guide screen, and thereafter, the process advances to the step S33. As a result of the process in the step S31, the character generator 34 stops outputting the character data, and thereby, the activating-operation guide screen is disappeared.

In the step S33, it is determined whether or not a current rotation angle of the ring RG1 is equivalent to “θoff”. When a determined result is YES, in a step S35, the power-off command is issued toward the sub CPU 38, and thereafter, the process is ended. When the determined result is NO, the process advances to a step S37 so as to initialize a placement of the focus lens 16 by controlling the driver 22b. Upon completion of initializing, the imaging task is activated in a step S39.

In a step S41, it is repeatedly determined whether or not the rotation angle of the ring RG1 is changed. When a determined result is updated from NO to YES, in a step S43, it is determined whether or not a current rotation angle of the ring RG1 falls below “θwide”. When the determined result is NO, the process advances to a step S45 so as to execute the focus tracking process by controlling the driver 22b. A position of the focus lens 16 is adjusted along the reference tracking curve set under the imaging task. Upon completion of the focus tracking process, the process returns to the step S41.

When the determined result of the step S43 is YES, in a step S47, a current time is set to the variable TIM1, and in a step S49, the character generator 34 is commanded to display an ending screen for a predetermined time period (=10 seconds). As a result of the process in the step S49, the character generator 34 outputs character data according to the command, and the LCD driver 30 drives the LCD monitor 32 based on the outputted character data. Thereby, the ending screen is displayed on the LCD monitor 32 for the predetermined time period.

In a step S51, the focus lens 16 is placed on the evacuation position by controlling the driver 22b. In a step S53, a flag FLGntc2 is set to “0”. Here, the flag FLGntc2 is a flag for identifying display/non-display of the end-operation guide screen, and “0” indicates a non-display whereas “1” indicates a display.

In a step S55, a current time is set to the variable TIM2. In the step S57, it is determined whether or not a current rotation angle of the ring RG1 is equivalent to “θoff”, and when a determined result is YES, the process advances to a step S67 whereas when the determined result is NO, the process advances to a step S59.

In the step S59, it is determined whether or not a numerical value obtained by subtracting the variable TIM1 from the variable TIM2 exceeds the threshold value THoff, and in a step S61, it is determined whether or not the flag FLGntc2 indicates “0”. When at least one of a determined result of the step S59 and a determined result of the step S61 is NO, the process directly returns to the step S55 whereas when both of the determined result of the step S59 and the determined result of the step S61 are YES, the process returns to the step S55 via processes in steps S63 to S65.

In the step S63, the character generator 34 is commanded to display the end-operation guide screen, and in the step S65, the flag FLGntc2 is updated to “1”. As a result of the process in the step S63, the character generator 34 outputs character data according to the command, and the LCD driver 30 drives the LCD monitor 32 based on the outputted character data. Thereby, the end-operation guide screen is displayed on the LCD monitor 32.

In the step S67, it is determined whether or not the flag FLGntc2 indicates “1”, and when a determined result is NO, the process directly advances to a step S71 whereas when the determined result is YES, the process advances to the step S71 after the character generator 34 is commanded to hide the end-operation guide screen in a step S69. As a result of the process in the step S69, the character generator 34 stops outputting the character data, and thereby, the end-operation guide screen is disappeared.

In the step S71, the predetermined ending process is executed, and in a step S73, the power-off command is issued toward the sub CPU 38. The power-source control task is ended after the process in the step S73.

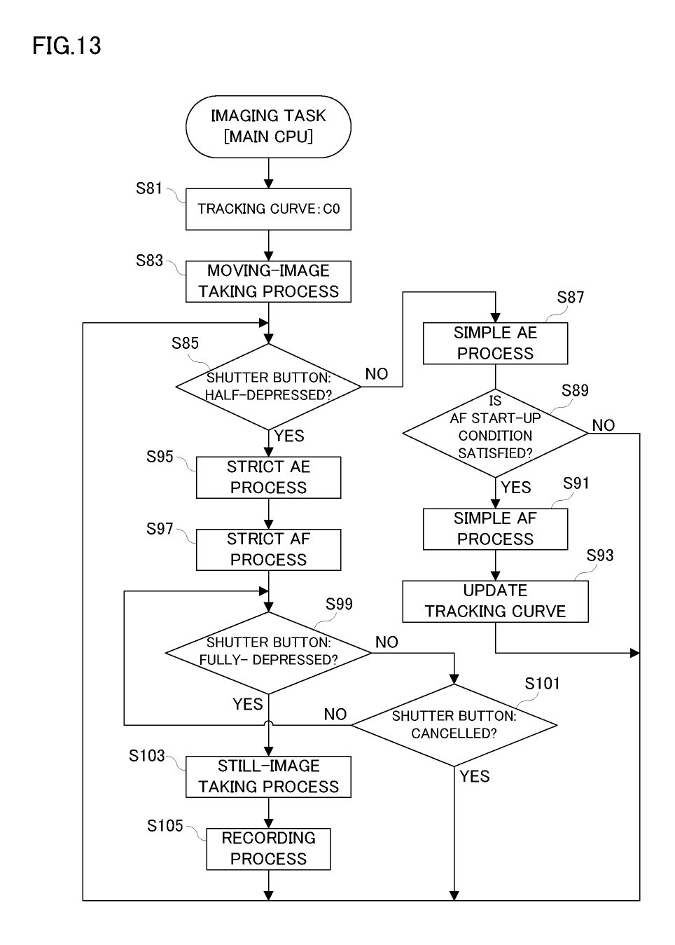

With reference to FIG. 13, in a step S81, the tracking curve is set to “C0”, and in a step S83, the moving-image taking process is executed. As a result, a live view image is displayed on the LCD monitor 32. In a step S85, it is determined whether or not the shutter button 40sh is half depressed, and when a determined result is YES, the process advances to a step S95 whereas when the determined result is NO, the process advances to a step S87.

In the step S87, the simple AE process is executed, and as a result, a brightness of a live view image is adjusted approximately. In a step S89, it is determined whether or not the predetermined AF start-up condition is satisfied, and when a determined result is NO, the process directly returns to the step S85 whereas when the determined result is YES, the process returns to the step S85 via processes in steps S91 to S93.

In the step S91, the simple AF process is executed, and thereby, a sharpness of a live view image is improved. In the step S93, coordinates equivalent to current positions of the zoom lens 12 and the focus lens 16 are detected from the graph shown in FIG. 8, and the reference tracking curve is updated to a tracking curve existing on the detected coordinates or a tracking curve created based on two tracking curves sandwiching the detected coordinates.

When the determined result of the step S85 is YES, in the step S95, the strict AE process is executed, and in a step S97, the strict AF process is executed. As a result, a brightness and a sharpness of a live view image is adjusted strictly. Upon completion of the strict AF process, in a step S99, it is determined whether or not the shutter button 40sh is fully depressed, and in a step S101, it is determined whether or not an operation of the shutter button 40sh is cancelled.

When a determined result of the step S101 is YES, the process returns to the step S85 whereas when a determined result of the step S99 is YES, in a step S103, the still-image taking process is executed. As a result of the process in the step S103, image data representing a scene at a time point at which the shutter button 40sh is fully depressed is evacuated from the YUV image are 28a to the still-image area 28b.

In a step S105, the memory I/F 46 is commanded to execute the recording process. The memory I/F 46 reads out the image data evacuated to the still-image area 28b through the memory control circuit 26 so as to record an image file containing the read-out image data on the recording medium 48. Upon completion of the recording process, the process returns to the step S85.

As can be seen from the above-described explanation, the ring RG1 is rotated across the angle ranges AR1 and AR2 lined up in the direction in which the angle is increased. When the rotation angle of the ring RG1 is increased to the angle θon belonging to the angle range AR1, the main power source is activated by the sub CPU 38 (S1 to S3). When the rotation angle of the ring RG1 is changed in the angle range AR2, the position of the zoom lens 12 is changed by the conversion unit CV1 and the sliding unit SL1. The main CPU 36 adjusts the placement of the focus lens 16 with reference to the changed position of the zoom lens 12 (S41 and S45). Moreover, when the period during which the rotation angle of the ring RG1 remains within the angle range AR1 exceeds the threshold value THon or THoff in a state where the main power source is activated, the main CPU 36 displays the activating-operation guide screen or the end-operation guide screen on the LCD monitor 30 (S11, S17 to S27, S43, S47, and S53 to S65).

Thus, the main power source is activated when the rotation angle of the ring RG1 is increased to the angle θon belonging to the angle range AR1, settings of the zoom lens 12 and the focus lens 16 are adjusted with reference to the rotation of the ring RG1 in the angle range AR2 lined up in the range AR1. Thereby, it becomes possible to control the main power source and the settings of the optical system by a single member, and therefore, an operability is improved. Moreover, when the rotation angle of the ring RG1 remains within the angle range AR1 in spite of the main power source having been activated, the notification is generated through the LCD monitor 30. The operator is capable of recognizing by the notification, that a current state is an activated state, and thereby, a consumed power is inhibited.

It is noted that, in this embodiment, a digital camera is assumed, however, the present invention may be applied to optical devices such as a microscope, a binocular, a telescope, and etc.

Moreover, in this embodiment, the activating-operation guide screen and/or the end-operation guide screen is outputted as the notification when the rotation of the ring RG1 is conducted. However, instead of these guide screens or together with these guide screens, a vibration and a sound may be outputted as the notification.

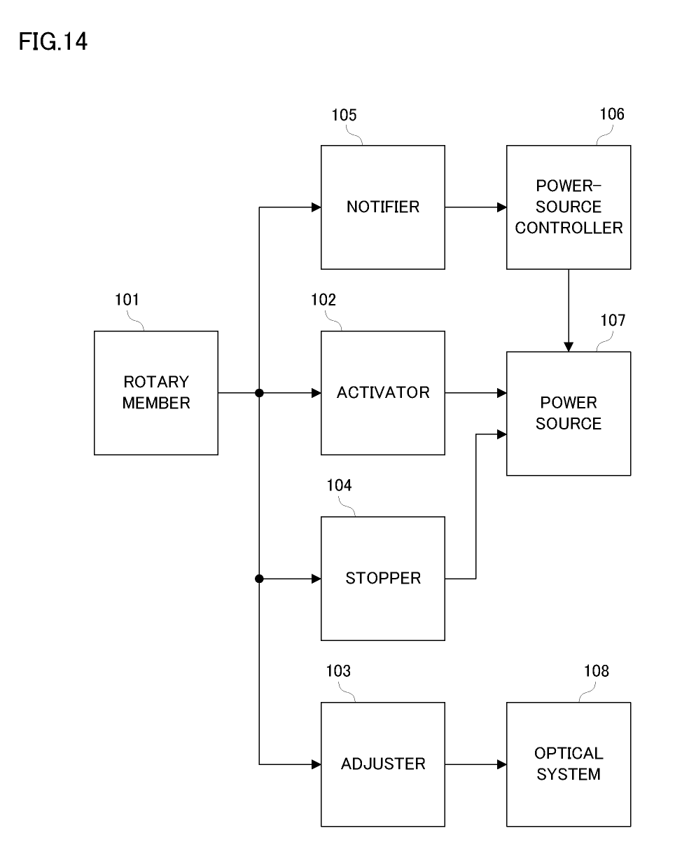

With reference to FIG. 14, an optical device according to one embodiment of the present invention is basically configured as follows: A rotary member 101 is rotated across a first angle range and a second angle range lined up in a direction in which an angle is increased. An activator 102 activates a power source 107 when a rotation angle of the rotary member 101 is increased to a first specific angle belonging to the first angle range. An adjuster 103 adjusts a setting of an optical system 108 with reference to a rotation of the rotary member 101 in the second angle range. A stopper 104 stops the power source 107 when the rotation angle of the rotary member 101 is decreased to a second specific angle belonging to the first angle range. A notifier 105 intermittently generates a notification in a partial period during which the rotation angle of the rotary member 101 remains within the first angle range, among periods from an activation by the activator 102 to a stop by the stopper 104. A power-source controller 106 stops/restarts the power source 107 corresponding to suspending/restarting the notification generated by the notifier 105.

The power source 107 is activated when the rotation angle of the rotary member 101 is increased to the first specific angle belonging to the first angle range, and is stopped when the rotation angle of the rotary member 101 is decreased to the second specific angle belonging to the first angle range. Moreover, the setting of the optical system 108 is adjusted with reference to the rotation of the rotary member 101 in the second angle range lined up in the first angle range.

However, the notification is generated when the rotation angle of the rotary member 101 remains within the first angle range in a state where the power source 107 is activated. Here, a generation manner of the notification is intermittent, and the power source 107 is stopped/restarted corresponding to suspending/restarting the notification. Thereby, it becomes possible to notify the operator of an operation error of the rotary member 101 while inhibiting the consumed power.

With reference to FIG. 15, a digital camera 210 according to this embodiment includes a power supply circuit 242. The power supply circuit 242 generates a plurality of direct current power supplies, each of which shows a different voltage value. One portion of the plurality of generated direct current power supplies is directly applied to a sub CPU 238, and another portion of the plurality of generated direct current power supplies is applied to circuits other than the sub CPU 238 via a switch group 244. Therefore, the sub CPU 238 is activated all the times, whereas the circuits other than the sub CPU 238 are activated/stopped in response to turning on/off of the switch group 244.

It is noted that a state where the circuits other than the sub CPU 238 are activated is defined as a “main-power-source on state”, and a state where the circuits other than the sub CPU 238 are stopped is defined as a “main-power-source off state”.

Moreover, the digital camera 210 includes a zoom lens 212 driven by a power-source and zoom control unit 220, and an aperture unit 214 and a focus lens 216 driven by drivers 22a and 22b, respectively. An optical image that underwent these components enters, with irradiation, an imaging surface of an imager 28, and is subjected to a photoelectric conversion.

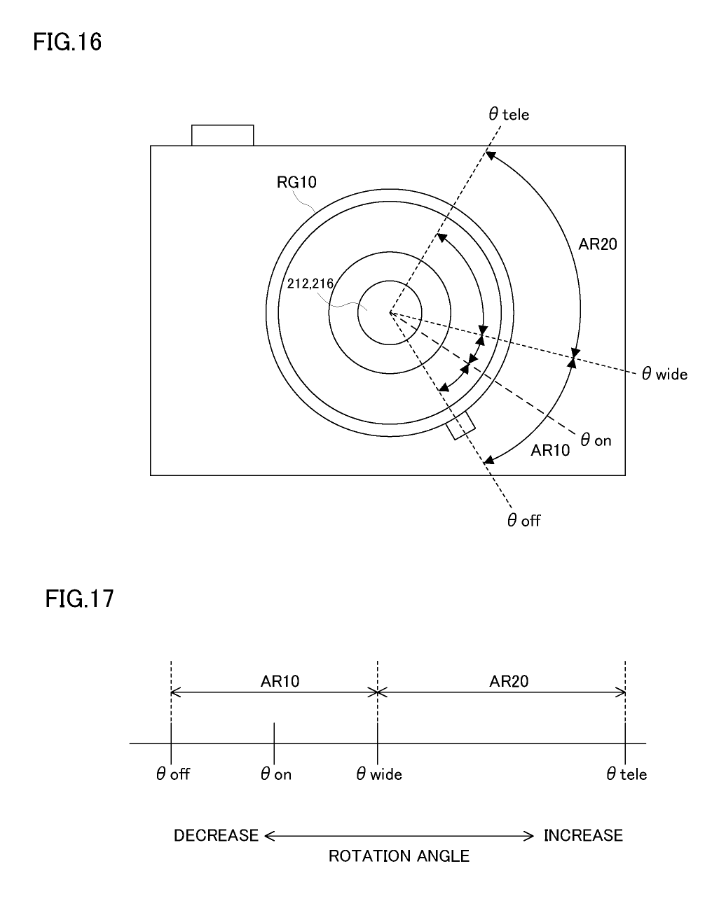

With reference to FIG. 16 to FIG. 18, the power-source and zoom control unit 220 is arranged on a front surface of a camera housing CB10 in a manner to surround the zoom lens 212, and has a ring RG10 capable of being rotated in a direction around an optical axis AX10 extending in a direction orthogonal to the imaging surface. The ring RG10 is capable of being rotated in a range from θoff to θtele, and this rotatable range is divided into angle ranges AR10 and AR20 lined up in a direction in which an angle is increased.

A lower limit angle and an upper limit angle of the angle range AR10 are respectively equivalent to “θoff” and “θwide”, and a lower limit angle and an upper limit angle of the angle range AR20 are respectively equivalent to “θwide” and “θtele”. Moreover, “θon” is assigned near a center of the angle range AR10.

In the angle range AR10, when a rotation angle of the ring RG10 is increased from “θoff” to “θon”, the sub CPU 238 turns on the switch group 244 in order to transition to the main-power-source on state, and furthermore, initializes a setting of an ASIC 252.

Firstly, an activated main CPU 236 applies a command to a character generator 234 under a power-source control task, in order to display a start screen shown in FIG. 19 (A) for a predetermined time period (=10 seconds) on an LCD monitor 232. The character generator 234 outputs character data according to the command, and an LCD driver 230 drives the LCD monitor 232 based on the outputted character data. As a result, the start screen is displayed on the LCD monitor 232 for the predetermined time period.

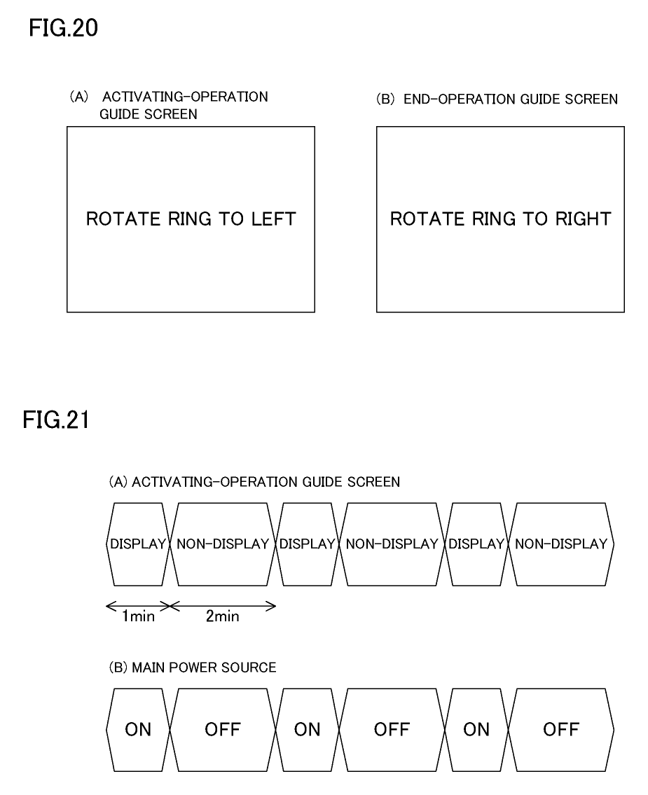

When a period during which the rotation angle of the ring RG10 remains within a range from “θon” to “θwide” reaches a threshold value THon (=10 seconds), the main CPU 236 commands the character generator 234 to display an activating-operation guide screen shown in FIG. 20 (A) (a notification screen urging an operation of rotating the ring RG10 to “θwide”). The character generator 234 outputs character data according to the command, and the LCD driver 230 drives the LCD monitor 232 based on the outputted character data. As a result, the activating-operation guide screen is displayed on the LCD monitor 232.

When a display time period of the activating-operation guide screen reaches a threshold value THinit1 (=1 minute) in a state where the rotation angle of the ring RG10 remains within the range from “θon” to “θwide”, the main CPU 236 continuously issues a restart-time setting command 1 and a power-off command toward the sub CPU 238.

The sub CPU 238 sets a time two minutes after a current time as a restart time in response to the restart-time setting command 1, and turns off the main power switch (turns off the switch group 244) in response to the continuously issued power-off command. The turned-off main power source is turned on by the sub CPU 238 when the restart time has arrived.

When the main power source is turned on as a result of the arrival of the restart time, the main CPU 236 applies a display command to the character generator 234 in order to quickly display the activating-operation guide screen on the LCD monitor 232. Thereafter, the above-described processes are repeated as long as the rotation angle of the ring RG10 remains within the range from “θon” to “θwide”. That is, in a state where the rotation angle of the ring RG10 remains within the range from “θon” to “θwide”, the activating-operation guide screen is intermittently displayed at a rate of one minute in three minutes (see FIG. 21 (A)), and the main power source is turned on/off corresponding to display/non-display of the activating-operation guide screen (see FIG. 21 (B)).

When the rotation angle of the ring RG10 reaches “θwide” in a main-power-source off period during an interval of the display of the activating-operation guide screen, similarly to the above-described case, the main power source is turned on and a setting of the ASIC252 is initialized by the sub CPU 238. On the other hand, these processes are omitted when the rotation angle of the ring RG10 reaches “θwide” while the display of the activating-operation guide screen.

When the rotation angle of the ring RG10 reaches “θwide”, under the power-source control task, the main CPU 236 controls the driver 222b so as to place the focus lens 216 at a default position. Upon completion of placing, an imaging task is activated by the power-source control task. When the activating-operation guide screen is displayed on the LCD monitor 232, the main CPU 236 commands the character generator 234 to hide the activating-operation guide screen before initializing a placement of the focus lens 216. The character generator 234 stops outputting the character data, and thereby, the activating-operation guide screen is disappeared.

It is noted that, in a state where the main power source is turned on, when the rotation angle of the ring RG10 is decreased to “θoff” without reaching “θwide”, the main CPU 236 issues a power-off command toward the sub CPU 238. The sub CPU 238 turns off the switch group 244 in order to transition to the main-power-source off state.

Under the imaging task activated by the power-source control task, in order to execute a moving-image taking process, the main CPU 236 commands a driver 222c to repeat an exposure procedure and an electric-charge reading-out procedure. In response to a vertical synchronization signal Vsync periodically generated, the driver 222c exposes the imaging surface of the imager 218 and reads out the electric charges produced on the imaging surface in a raster scanning manner. From the imager 218, raw image data that is based on the read-out electric charges is cyclically outputted.

A signal processing circuit 224 performs a white balance adjustment, a color separation and a YUV conversion, on the raw image data outputted from the imager 218. YUV formatted image data produced thereby is written into a YUV image area 228a of an SDRAM 228 through a memory control circuit 226. The LCD driver 230 repeatedly reads out the image data stored in the YUV image area 228a through the memory control circuit 226, and drives the LCD monitor 232 based on the read-out image data. As a result, a real-time moving image (a live view image) representing the scene captured on the imaging surface is displayed on the monitor screen.

Moreover, the signal processing circuit 224 applies Ydata forming the image data to the main CPU 236. The main CPU 236 performs an AE process on the applied Y data so as to calculate an appropriate EV value. An aperture amount and an exposure time period that define the calculated appropriate EV value are respectively set to the drivers 222a and 222c. Thereby, a brightness of a live view image is adjusted approximately.

Moreover, when a predetermined AF start-up condition is satisfied, the main CPU 236 executes a simple AF process based on a high-frequency component of the Y data applied from the signal processing circuit 224. Thereby, the focus lens 216 is placed at a focal point, and as a result, a sharpness of a live view image is improved.

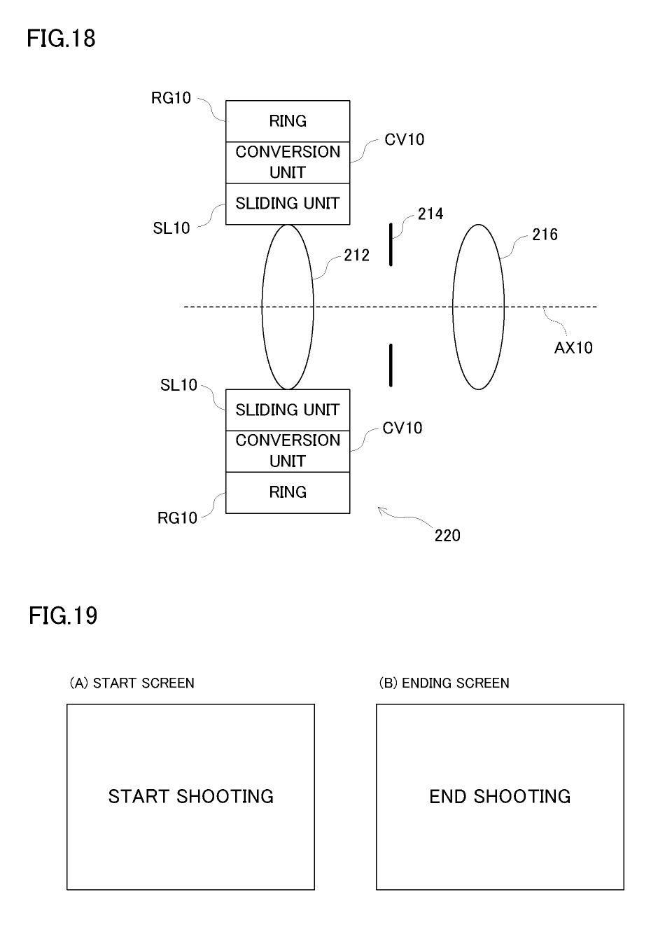

With reference to FIG. 18 again, the power-source and zoom control unit 220 further includes a conversion unit CV10 which converts a rotation movement of the ring RG10 in the angle range AR20 to a linear movement along the optical axis AX10. A sliding unit SL10 slides the zoom lens 212 to a direction along the optical axis AX10 by using the linear movement converted by the conversion unit CV10. The zoom lens 212 is placed at a wide end when the rotation angle indicates “θwide”, and is moved to a tele side along with an increase of the rotation angle in the angle range AR20. Then, the zoom lens 212 is placed at a tele end when the rotation angle indicates “θtele”. A zoom magnification of a live view image changes along with the movement of the focus lens 212.

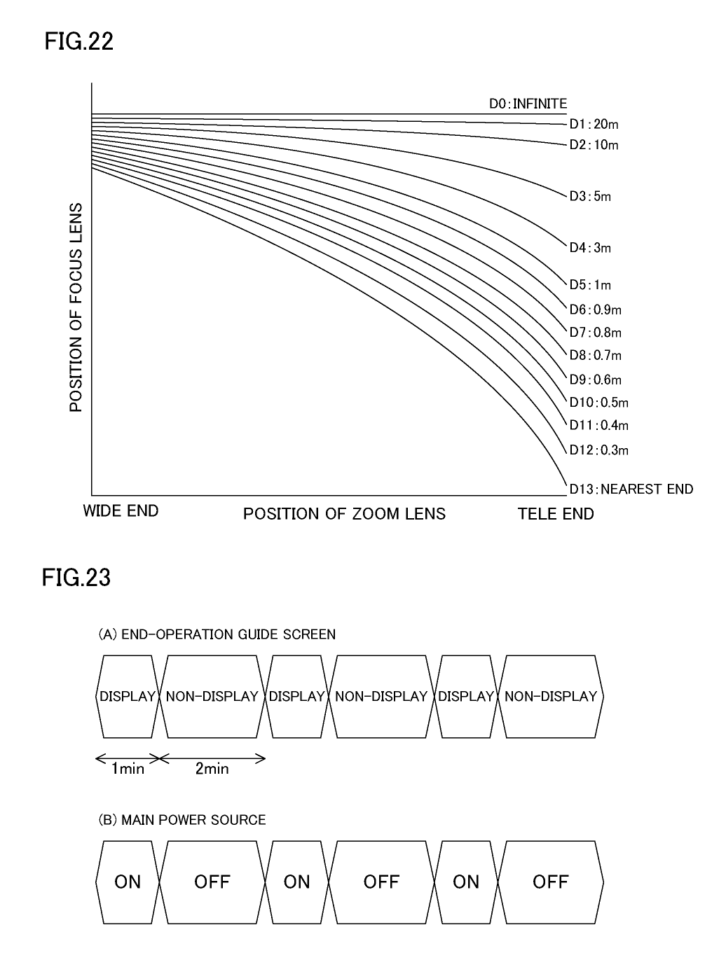

In a flash memory 250, graph data equivalent to tracking curves D0 to D13 shown in FIG. 22 is stored. With reference to FIG. 22, when a depth of field is “infinite”, a focal position changes in a manner to move along the tracking curve D0 relative to a position of the zoom lens 212. Moreover, when the depth of field is “20 m”, the focal position changes in a manner to move along the tracking curve D1 relative to the position of the zoom lens 212. Furthermore, when the depth of field is “10 m”, the focal position changes in a manner to move along the tracking curve D2 relative to the position of the zoom lens 212.

Likewise, when the depths of field are “5 m”, “3 m”, “1 m”, “0.9 m”, “0.8 m”, “0.7 m”, “0.6 m”, “0.5 m”, “0.4 m”, “0.3 m”, and “nearest end”, the focal positions change in a manner to move along the tracking curves D3, d4, D5, D6, D7, D8, D9, D10, D11, D12, and D13 relative to the position of the zoom lens 212, respectively.

Initially when the imaging task is activated, the tracking curve D0 is set as a reference tracking curve. In this regard, coordinates equivalent to current positions of the zoom lens 212 and the focus lens 216 are detected from the graph shown in FIG. 22 at every time the simple AF process is completed. The reference tracking curve is updated to a tracking curve existing on the detected coordinates or a tracking curve created based on two tracking curves sandwiching the detected coordinates.

When the position of the zoom lens 212 is changed by the rotation of the ring RG10, under the power-source control task, the main CPU 236 executes a focus tracking process with reference to the changed position of the zoom lens 212. The focus lens 216 is moved in an optical-axis direction along the reference tracking curve set under the imaging task.

When a shutter button 240sh arranged in a key input device 240 is half depressed, under the imaging task, the main CPU 236 executes a strict AE process that is based on the Y data applied from the signal processing circuit 224 so as to calculate an optimal EV value. Similarly to the above-described case, an aperture amount and an exposure time period that define the calculated optimal EV value are respectively set to the drivers 222a and 222c. As a result, a brightness of a live view image is adjusted strictly.

Moreover, under the imaging task, the main CPU 236 executes a strict AF process that is based on the high-frequency component of the Y data applied from the signal processing circuit 224. Thereby, the focus lens 216 is placed at a focal point, and as a result, a sharpness of a live view image is improved. When the shutter button 240sh is fully depressed, the main CPU 236 executes a still-image taking process, and concurrently, commands a memory I/F 246 to execute a recording process.

Photographed image data representing a scene at a time point at which the shutter button 240sh is fully depressed is evacuated from the YUV image are 228a to a still-image area 228b by the still-image taking process. The memory I/F 246 commanded to execute the recording process reads out the photographed image data evacuated to the still-image area 228b through the memory control circuit 226 so as to record an image file containing the read-out photographed image data on a recording medium 248.

When the rotation angle of the ring RG10 falls below “θwide”, the main CPU 236 applies a command to the character generator 234 under the power-source control task in order to display an ending screen shown in FIG. 19 (B) for a predetermined time period (=10 seconds), and furthermore, places the focus lens 216 on an evacuation position by controlling the driver 222b. The character generator 234 outputs character data according to the command, and the LCD driver 230 drives the LCD monitor 232 based on the outputted character data. As a result, the ending screen is displayed on the LCD monitor 232 for the predetermined time period.

When a period during which the rotation angle of the ring RG10 remains within a range from “θwide” to “θoff” reaches a threshold value THoff (=10 seconds), under the power-source control task, the main CPU 236 commands the character generator 234 to display an end-operation guide screen shown in FIG. 20 (B) (a notification screen urging an operation of rotating the ring RG1 to “θoff”). The character generator 234 outputs character data according to the command, and the LCD driver 230 drives the LCD monitor 232 based on the outputted character data. As a result, the end-operation guide screen is displayed on the LCD monitor 232.

When a display time period of the end-operation guide screen reaches a threshold value THinit2 (1 minute) in a state where the rotation angle of the ring RG10 remains within the range from “θwide” to “θoff”, the main CPU 236 continuously issues a restart-time setting command 2 and the power-off command toward the sub CPU 238.

The sub CPU 238 sets a time two minutes after a current time as a restart time in response to the restart-time setting command 2, and turns off the main power switch (turns off the switch group 244) in response to the continuously issued power-off command. The turned-off main power source is turned on by the sub CPU 238 when the restart time has arrived.

When the main power source is turned on as a result of the arrival of the restart time, the main CPU 236 applies a display command to the character generator 234 in order to quickly display the end-operation guide screen on the LCD monitor 232. Thereafter, the above-described processes are repeated as long as the rotation angle of the ring RG10 remains within the range from “θwide” to “θoff”. That is, in a state where the rotation angle of the ring RG10 remains within the range from “θwide” to “θoff”, the end-operation guide screen is intermittently displayed at a rate of one minute in three minutes (see FIG. 23 (A)), and the main power source is turned on/off corresponding to display/non-display of the end-operation guide screen (see FIG. 23 (B)).

When the rotation angle of the ring RG10 reaches “θoff” in a state where the main power source is turned on, the main CPU 236 executes a predetermined ending process, and issues the power-off command toward the sub CPU 238. The sub CPU 238 turns off the switch group 244 in order to transition to the main-power-source off state.

It is noted that, when the end-operation guide screen is displayed on the LCD monitor 232, the main CPU 236 commands the character generator 234 to hide the end-operation guide screen before executing the ending process. The character generator 234 stops outputting the character data, and thereby, the end-operation guide screen is disappeared.

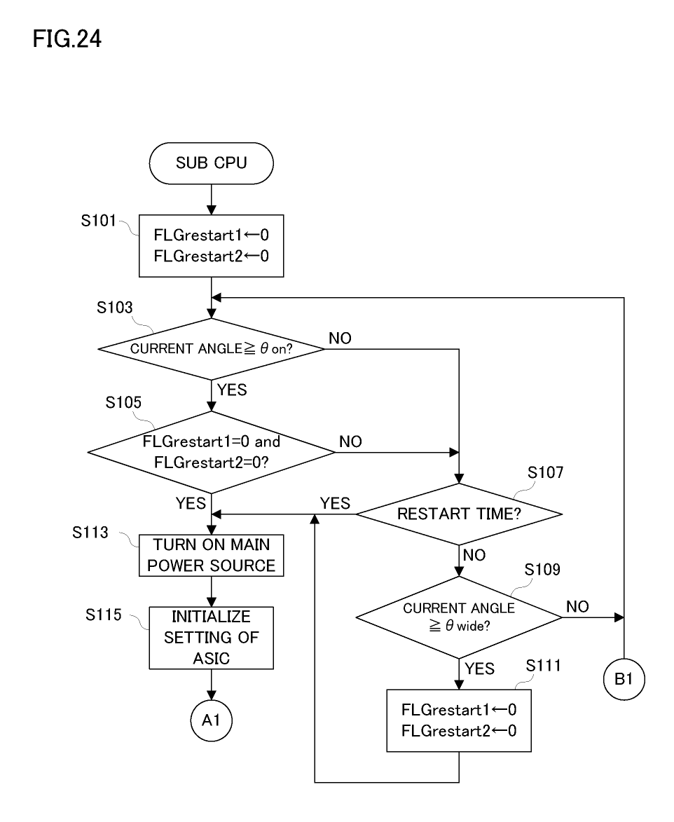

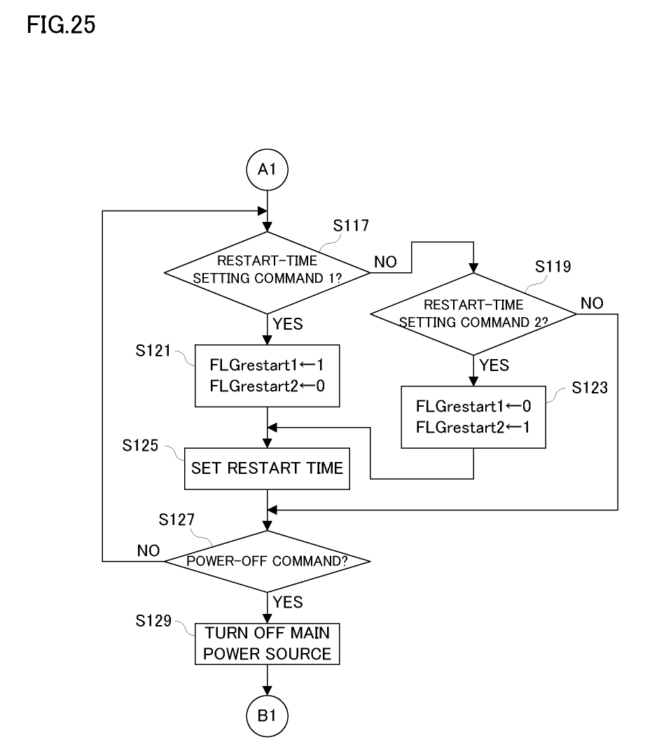

The sub CPU 238 executes a flowchart shown in FIG. 24. It is noted that a control program corresponding to the flowchart is stored in a memory 238m.

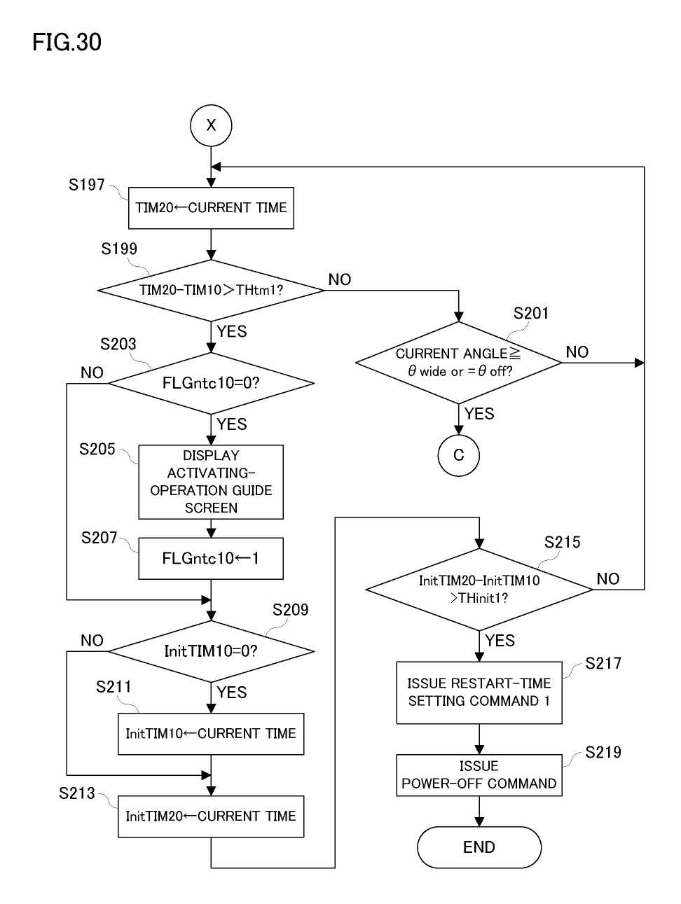

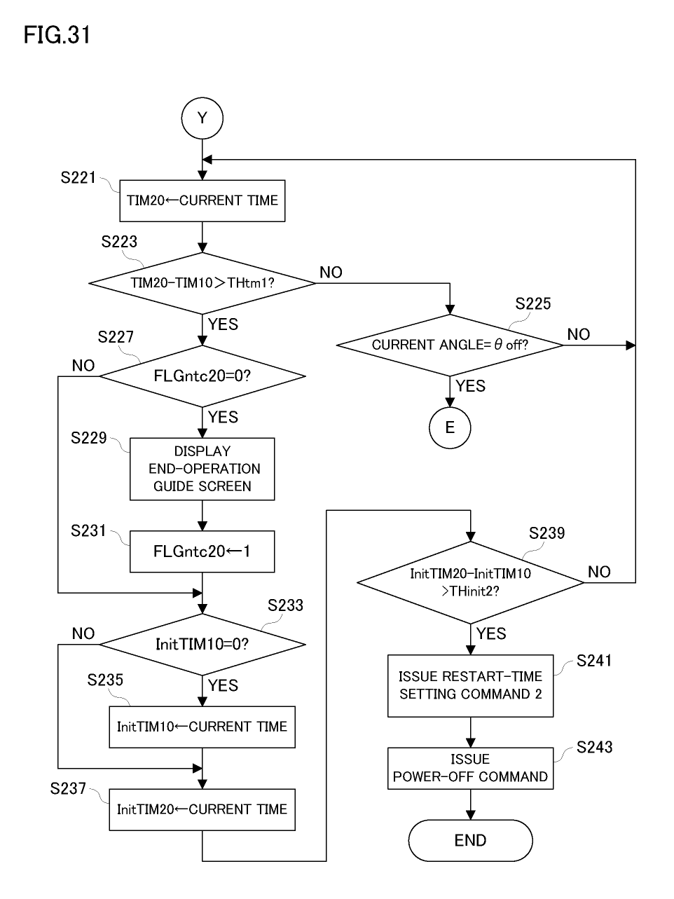

In a step S101, flags FLGrestart1 and FLGrestart2 are set to “0”. Each of the flags FLGrestart1 and FLGrestart2 is a flag for controlling a flow of processes of the main CPU 236 under the power-source control task. The main CPU 236 is quickly transitioned to a step S197 shown in FIG. 30 when being activated in a state where the flag FLGrestart1 indicates “1” whereas is quickly transitioned to a step S221 shown in FIG. 31 when being activated in a state where the flag FLGrestart2 indicates “1”.

Returning to FIG. 24, in a step S103, it is determined whether or not a current rotation angle of the ring RG10 is equal to or more than “θon”, and in a step S105, it is determined whether or not both of the flags FLGrestart1 and FLGrestart2 indicate “0”. Moreover, in a step S017, it is determined whether or not a restart time has arrived, and in a step S109, it is determined whether or not a current rotation angle of the ring RG10 is equal to or more than “θwide”.

When the rotation angle of the ring RG10 is increased to “θon” in a state where both of the flags FLGrestart1 and FLGrestart2 indicate “0”, the process advances to a step S113 via the steps S103 and S105. Moreover, when the restart time has arrived in a state where any one of the flags FLGrestart1 and FLGrestart2 indicates “1”, the process advances to the step S113 via the step S107. Furthermore, when the rotation angle of the ring RG10 is increased to “θwide” in a state where any one of the flags FLGrestart1 and FLGrestart2 indicates “1”, the process advances to the step S113 after the process similar to the step S101 described above is executed in a step S111.

In the step S113, the main power source is turned on (the switch group 244 is turned on), and in a subsequent step S115, a setting of the ASIC252 is initialized. Upon completion of initializing, in a step S117, it is determined whether or not the restart-time setting command 1 is issued from the main CPU 236, and in a step S119, it is determined whether or not the restart-time setting command 2 is issued from the main CPU 236.

When a determined result of the step S117 is YES, the process advances to a step S121 so as to set the flag FLGrestart1 to “1” and set the flag FLGrestart2 to “0”. When a determined result of the step S119 is YES, the process advances to a step S123 so as to set the flag FLGrestart1 to “0” and set the flag FLGrestart2 to “1”. Upon completion of the process in the step S121 or S123, in a step S125, the restart time is set, and thereafter the process advances to a step S127. It is noted that, when both of the determined result of the step S117 and the determined result of the step S119 are NO, the process directly advances to the step S127.

In the step S127, it is determined whether or not the power-off command is issued from the main CPU 236. When a determined result is NO, the process returns to the step S117, and when the determined result is YES, in a step S129, the main power source is turned off (the switch group 244 is turned off), and thereafter, the process returns to the step S103.

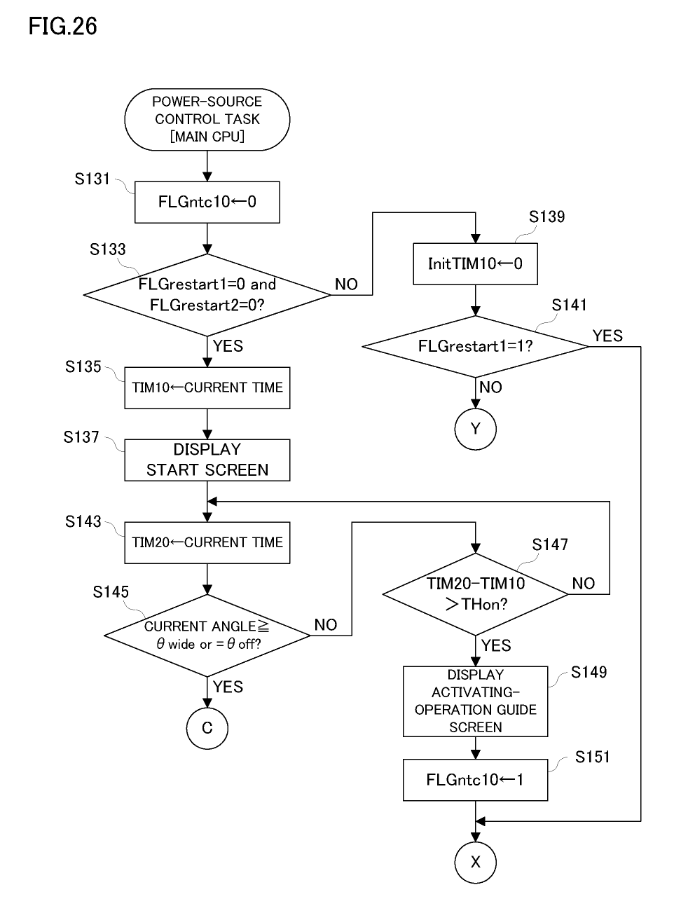

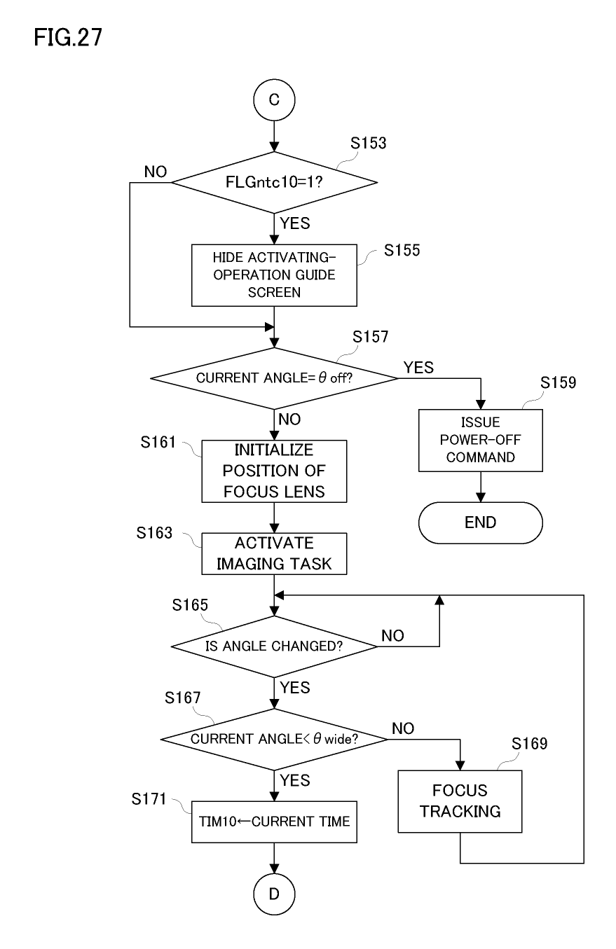

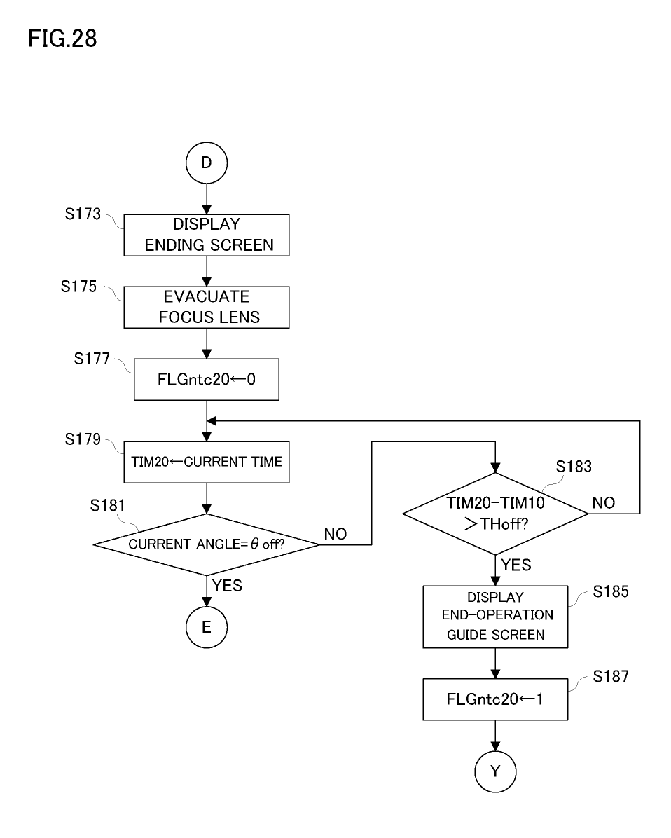

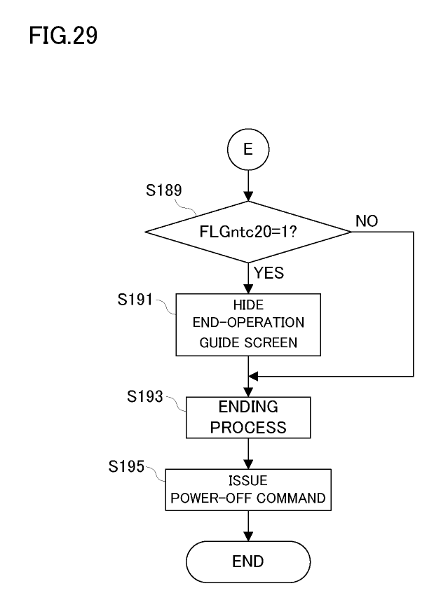

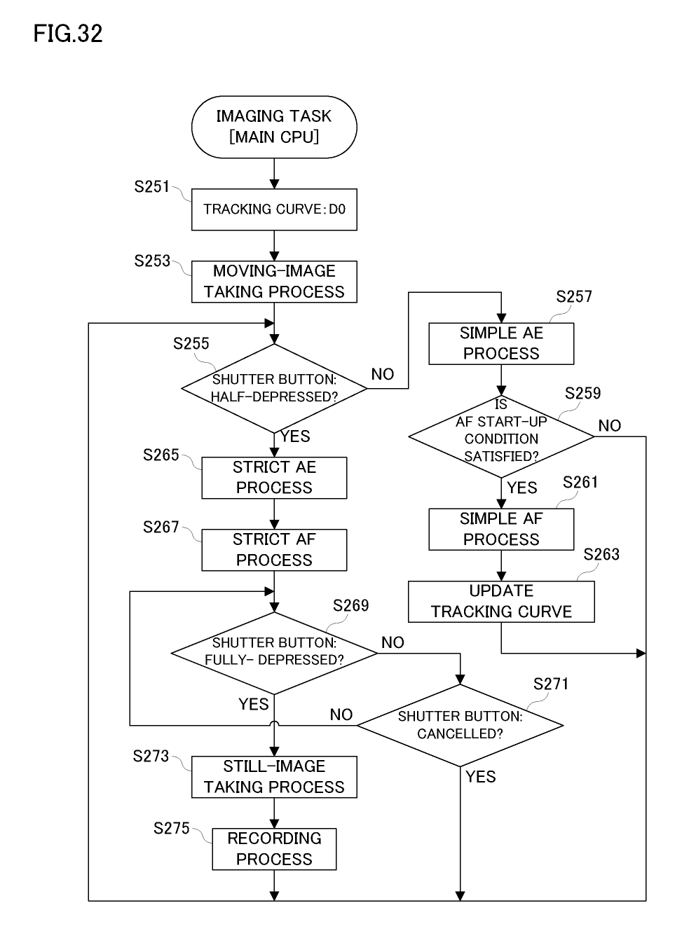

The main CPU 236 executes a plurality of tasks including the power-source control task shown in FIG. 26 to FIG. 31 and the imaging task shown in FIG. 32, in a parallel manner. It is noted that control programs corresponding to these tasks are stored in the flash memory 250.

With reference to FIG. 26, in a step S131, a flag FLGntc10 is set to “0”. Here, the flag FLGntc10 is a flag for identifying display/non-display of the activating-operation guide screen, and “0” indicates a non-display whereas “1” indicates a display. In a step S133, it is determined whether or not both of the flags FLGrestart1 and FLGrestart2 are “0”. When a determined result is NO, the process advances to a step S139 whereas when the determined result is YES, the process advances to a step S135.

In the step S139, a variable InitTIM10 is set to “0”, and in a subsequent step S141, it is determined that any of the flags FLGrestart1 and FLGrestart2 indicates “1”. When the flag FLGrestart1 indicates “1”, the process advances to the step S197 from the step S141, whereas when the flag FLGrestart2 indicates “1”, the process advances to the step S221 from the step S141.

In the step S135, a current time is set to a variable TIM10, and in a step S137, the character generator 234 is commanded to display the start screen for a predetermined time period (=10 seconds). The character generator 234 outputs character data according to the command, and the LCD driver 230 drives the LCD monitor 232 based on the outputted character data. As a result, the start screen is displayed on the LCD monitor 232 for the predetermined time period.

In a step S143, a current time is set to a variable TIM20. In a step S145, it is determined whether or not an OR condition under which a current rotation angle of the ring RG10 is equal to or more than “θwide” or the current rotation angle of the ring RG10 is equivalent to “θoff” is satisfied. In the step S147, it is determined whether or not a numerical value obtained by subtracting the variable TIM10 from the variable TIM20 exceeds the threshold value THon.

When both of a determined result of the step S145 and a determined result of the step S147 are NO, the process returns to the step S143. When the determined result of the step S145 is YES, the process advances to a step S153, and when the determined result of the step S147 is YES, the process advances to a step S149.

In the step S149, the character generator 234 is commanded to display the activating-operation guide screen, and in a step S151, the flag FLGntc10 is updated to “1”. As a result of the process in the step S149, the character generator 234 outputs character data according to the command, and the LCD driver 230 drives the LCD monitor 232 based on the outputted character data. Thereby, the activating-operation guide screen is displayed on the LCD monitor 232.

In the step S153, it is determined whether or not the flag FLGntc10 indicates “1”, and when a determined result is NO, the process directly advances to a step S157 whereas when the determined result is YES, in a step S155, the character generator 234 is commanded to hide the activating-operation guide screen, and thereafter, the process advances to the step S157. As a result of the process in the step S155, the character generator 234 stops outputting the character data, and thereby, the activating-operation guide screen is disappeared.

In the step S157, it is determined whether or not a current rotation angle of the ring RG10 is equivalent to “θoff”. When a determined result is YES, in a step S159, the power-off command is issued toward the sub CPU 238, and thereafter, the process is ended. When the determined result is NO, the process advances to a step S161 so as to initialize a placement of the focus lens 216 by controlling the driver 222b. Upon completion of initializing, the imaging task is activated in a step S163.

In a step S165, it is repeatedly determined whether or not the rotation angle of the ring RG10 is changed. When a determined result is updated from NO to YES, in a step S167, it is determined whether or not a current rotation angle of the ring RG10 falls below “θwide”. When the determined result is NO, the process advances to a step S169 so as to execute the focus tracking process by controlling the driver 222b. A position of the focus lens 216 is adjusted along the reference tracking curve set under the imaging task. Upon completion of the focus tracking process, the process returns to the step S165.

When the determined result of the step S167 is YES, in a step S171, a current time is set to the variable TIM10. In a step S173, the character generator 234 is commanded to display the ending screen for a predetermined time period (=10 seconds). The character generator 234 outputs character data according to the command, and the LCD driver 230 drives the LCD monitor 232 based on the outputted character data. Thereby, the ending screen is displayed on the LCD monitor 232 for the predetermined time period.

In a step S175, the focus lens 216 is placed on the evacuation position by controlling the driver 222b. In a step S177, a flag FLGntc20 is set to “0”. Here, the flag FLGntc20 is a flag for identifying display/non-display of the end-operation guide screen, and “0” indicates a non-display whereas “1” indicates a display.

In a step S179, a current time is set to the variable TIM20. In the step S181, it is determined whether or not a current rotation angle of the ring RG10 is equivalent to “θoff”, and in a step S183, it is determined whether or not a numerical value obtained by subtracting the variable TIM10 from the variable TIM20 exceeds the threshold value THoff.

When both of a determined result of the step S181 and a determined result of the step S183 are NO, the process returns to the step S179. When the determined result of the step S181 is YES, the process advances to a step S189, and when the determined result of the step S183 is YES, the process advances to a step S185.

In the step S185, the character generator 234 is commanded to display the end-operation guide screen, and in a subsequent step S187, the flag FLGntc20 is updated to “1”. Upon completion of the process in the step S187, the process advances to the step S221. As a result of the process in the step S185, the character generator 234 outputs character data according to the command, and the LCD driver 230 drives the LCD monitor 232 based on the outputted character data. Thereby, the end-operation guide screen is displayed on the LCD monitor 232.

In the step S189, it is determined whether or not the flag FLGntc20 indicates “1”, and when a determined result is NO, the process directly advances to a step S193 whereas when the determined result is YES, the process advances to the step S193 after the character generator 234 is commanded to hide the end-operation guide screen in a step S191. As a result of the process in the step S191, the character generator 234 stops outputting the character data, and thereby, the end-operation guide screen is disappeared.

In the step S193, the predetermined ending process is executed, and in a step S195, the power-off command is issued toward the sub CPU 238. The power-source control task is ended after the process in the step S195.

In the step S197, a current time is set to the variable TIM20. In a step S199, it is determined whether or not a numerical value obtained by subtracting the variable TIM10 from the variable TIM20 exceeds a threshold value THtm1. In a step S201, it is determined whether or not the OR condition under which a current rotation angle of the ring RG10 is equal to or more than “θwide” or the current rotation angle of the ring RG10 is equivalent to “θoff” is satisfied. When both of a determined result of the step S199 and a determined result of the step S201 are NO, the process returns to the step S197. When the determined result of the step S201 is YES, the process transitions to the step S153, and when the determined result of the step S199 is YES, the process advances to a step S203.

In the step S203, it is determined whether or not the flag FLGntc10 indicates “0”, and when a determined result is NO, the process directly advances to a step S209 whereas when the determined result is YES, the process advances to the step S209 via processes in steps S205 to D207. In the step S205, the character generator 234 is commanded to display the activating-operation guide screen, and in the step S207, the flag FLGntc10 is updated to “1”.

As a result of the process in the step S205, the character generator 234 outputs character data according to the command, and the LCD driver 230 drives the LCD monitor 232 based on the outputted character data. Thereby, the activating-operation guide screen is displayed on the LCD monitor 232.

In the step S209, it is determined whether or not the variable InitTIM10 is “0”, and when a determined result is NO, the process directly advances to a step S213 whereas when the determined result is YES, a current time is set to the variable InitTIM10 in a step S211, and thereafter, the process advances to the step S213. In the step S213, a current time is set to a variable InitTIM20, and in a step S215, it is determined whether or not a numerical value obtained by subtracting the variable InitTIM10 from the variable InitTIM20 exceeds a threshold value THinit1.

When a determined result is NO, the process returns to the step S197 whereas when the determined result is YES, the process advances to a step S217. In the step S217, the restart-time setting command 1 is issued toward the sub CPU 238, and in a subsequent step S219, the power-off command is issued toward the sub CPU 238. The power-source control task is ended after the process in the step S219.

In the step S221, a current time is set to the variable TIM20. In a step S223, it is determined whether or not a numerical value obtained by subtracting the variable TIM10 from the variable TIM20 exceeds the threshold value THtm1, and in a step S225, it is determined whether or not the current rotation angle of the ring RG10 is equivalent to “θoff”. When both of a determined result of the step S223 and a determined result of the step S225 are NO, the process returns to the step S221. When the determined result of the step S225 is YES, the process transitions to the step S189, and when the determined result of the step S223 is YES, the process advances to a step S227.

In the step S227, it is determined whether or not the flag FLGntc20 indicates “0”, and when a determined result is NO, the process directly advances to a step S233 whereas when the determined result is YES, the process advances to the step S233 via processes in steps S229 to S231. In the step S229, the character generator 234 is commanded to display the end-operation guide screen, and in the step S231, the flag FLGntc20 is updated to “1”.

As a result of the process in the step S229, the character generator 234 outputs character data according to the command, and the LCD driver 230 drives the LCD monitor 232 based on the outputted character data. Thereby, the end-operation guide screen is displayed on the LCD monitor 232.

In the step S233, it is determined whether or not the variable InitTIM10 is “0”, and when a determined result is NO, the process directly advances to a step S237 whereas when the determined result is YES, a current time is set to the variable InitTIM10 in a step S235, and thereafter, the process advances to the step S237. In the step S237, a current time is set to the variable InitTIM20, and in a step S239, it is determined whether or not a numerical value obtained by subtracting the variable InitTIM10 from the variable InitTIM20 exceeds a threshold value THinit2.

When a determined result is NO, the process returns to the step S221 whereas when the determined result is YES, the process advances to a step S241. In the step S241, the restart-time setting command 2 is issued toward the sub CPU 238, and in a subsequent step S243, the power-off command is issued toward the sub CPU 238. The power-source control task is ended after the process in the step S243.

With reference to FIG. 32, in a step S251, the tracking curve is set to “D0”, and in a step S253, the moving-image taking process is executed. As a result, a live view image is displayed on the LCD monitor 232. In a step S255, it is determined whether or not the shutter button 240sh is half depressed, and when a determined result is YES, the process advances to a step S265 whereas when the determined result is NO, the process advances to a step S257.

In the step S257, the simple AE process is executed, and as a result, a brightness of a live view image is adjusted approximately. In a step S259, it is determined whether or not the predetermined AF start-up condition is satisfied, and when a determined result is NO, the process directly returns to the step S255 whereas when the determined result is YES, the process returns to the step S255 via processes in steps S261 to S263.

In the step S261, the simple AF process is executed, and thereby, a sharpness of a live view image is improved. In the step S263, coordinates equivalent to current positions of the zoom lens 212 and the focus lens 216 are detected from the graph shown in FIG. 22, and the reference tracking curve is updated to a tracking curve existing on the detected coordinates or a tracking curve created based on two tracking curves sandwiching the detected coordinates.

When the determined result of the step S255 is YES, in the step S65, the strict AE process is executed, and in a step S267, the strict AF process is executed. As a result, a brightness and a sharpness of a live view image is adjusted strictly. Upon completion of the strict AF process, in a step S269, it is determined whether or not the shutter button 240sh is fully depressed, and in a step S1271 it is determined whether or not an operation of the shutter button 240sh is cancelled.

When a determined result of the step S271 is YES, the process returns to the step S255 whereas when a determined result of the step S269 is YES, in a step S273, the still-image taking process is executed. As a result of the process in the step S273, image data representing a scene at a time point at which the shutter button 240sh is fully depressed is evacuated from the YUV image are 228a to the still-image area 228b.

In a step S275, the memory I/F 46 is commanded to execute the recording process. The memory I/F 246 reads out the image data evacuated to the still-image area 228b through the memory control circuit 226 so as to record an image file containing the read-out image data on the recording medium 248. Upon completion of the recording process, the process returns to the step S255.

As can be seen from the above-described explanation, the ring RG10 is rotated across the angle ranges AR10 and AR20 lined up in the direction in which the angle is increased. When the rotation angle of the ring RG10 is increased to the angle θon belonging to the angle range AR10, the main power source is activated by the sub CPU 238 (S103 to S105 and S113). The position of the zoom lens 212 is changed along with the rotation of the ring RG10 in the angle range AR20, and the main CPU 236 adjusts the placement of the focus lens 216 with reference to the changed position of the zoom lens 212 (S165 and S169). When the rotation angle of the ring RG10 is decreased to the angle θoff belonging to the angle range AR10, the main power source is stopped in cooperation with the main CPU 236 and the sub CPU 238 (S157 to S159, S181, S195, S225, and S127 to S129). The main CPU 236 intermittently displays the activating-operation guide screen or the end-operation guide screen (the notification) on the LCD monitor 232, in a partial period during which the rotation angle of the ring RG10 remains within the angle range AR10, among periods of activating and stopping the main power source (S131 to S151, S167, S171 to S187 and S197˜S243). The sub CPU 238 stops/restarts the main power source corresponding to suspending/restarting the notification (S107, S113 and S117 to S129).

The main power source is activated when the rotation angle of the ring RG10 is increased to the angle θon belonging to the angle range AR10, and is stopped when the rotation angle of the ring RG10 is decreased to the angle θoff belonging to the angle range AR10. Moreover, the settings of the zoom lens 212 and the focus lens 216 are adjusted with reference to the rotation of the ring RG10 in the angle range AR20 lined up in the angle range AR10.

However, the notification is generated when the rotation angle of the ring RG10 remains within the angle range AR10 in a state where the main power source is activated. Here, the generation manner of the notification is intermittent, and the main power source is stopped/restarted corresponding to suspending/restarting the notification. Thereby, it becomes possible to notify the operator of an operation error of the ring RG10 while inhibiting the consumed power.

It is noted that, in this embodiment, a digital camera is assumed, however, the present invention may be applied to optical devices such as a microscope, a binocular, a telescope, and etc.

Moreover, in this embodiment, the activating-operation guide screen and/or the end-operation guide screen is outputted as the notification when the rotation of the ring RG10 is conducted. However, instead of these guide screens or together with these guide screens, a vibration and a sound may be outputted as the notification.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical device comprising:
a rotary member which is rotated across a first angle range and a second angle range lined up in a direction in which an angle is increased;
an activator which activates a power source when a rotation angle of said rotary member is increased to a first specific angle belonging to the first angle range;
an adjuster which adjusts a setting of an optical system with reference to a rotation of said rotary member in the second angle range; and
a notifier which generates a notification when the rotation angle of said rotary member remains within the first angle range in a state where said power source is activated.

2. An optical device according to claim 1, wherein said notifier includes a first measurer which measures, in response to a process of said activator, a period during which the rotation angle of said rotary member remains within the first angle range without reaching the second angle range, and a first notification generator which generates a first notification with reference to the period measured by said first measurer.

3. An optical device according to claim 1, further comprising a stopper which stops said power source when the rotation angle of said rotary member is decreased to a second specific angle belonging to the first angle range.

4. An optical device according to claim 3, wherein said notifier includes a detector which detects a transition of the rotation angle of said rotary member from the second angle range to the first angle range, a second measurer which measures, in response to a detection of said detector, a period during which the rotation angle of said rotary member remains within the first angle range without reaching the second specific angle, and a second notification generator which generates a second notification with reference to the period measured by said second measurer.

5. An optical device according to claim 3, wherein said second specific angle is equivalent to an angle narrower than the first specific angle.

6. An optical device according to claim 1, further comprising:
a processor which processes electronic data based on output of said optical system; and
an initializer which initializes a setting of said processor in association with the process of said activator.

7. An optical device according to claim 1, further comprising an imager which outputs an electronic image representing a scene captured on an imaging surface, wherein said optical system includes a zoom lens arranged on a front of said imaging surface, and said adjuster includes a zoom adjusting unit which adjusts a position of said zoom lens in accordance with the rotation of said rotary member.

8. An operation control program recorded on a non-transitory recording medium in order to control an optical device provided with a rotary member which is rotated across a first angle range and a second angle range lined up in a direction in which an angle is increased, and an adjuster which adjusts a setting of an optical system with reference to a rotation of said rotary member in the second angle range, the program causing a processor of the optical device to perform the steps comprising:
an activating step of activating a power source when a rotation angle of said rotary member is increased to a first specific angle belonging to the first angle range; and
a notifying step of generating a notification when the rotation angle of said rotary member remains within the first angle range in a state where said power source is activated.

9. An operation control method executed by an optical device provided with a rotary member which is rotated across a first angle range and a second angle range lined up in a direction in which an angle is increased, and an adjuster which adjusts a setting of an optical system with reference to a rotation of said rotary member in the second angle range, comprising:
an activating step of activating a power source when a rotation angle of said rotary member is increased to a first specific angle belonging to the first angle range; and
a notifying step of generating a notification when the rotation angle of said rotary member remains within the first angle range in a state where said power source is activated.

10. An optical device comprising:
a rotary member which is rotated across a first angle range and a second angle range lined up in a direction in which an angle is increased;
an activator which activates a power source when a rotation angle of said rotary member is increased to a first specific angle belonging to the first angle range;
an adjuster which adjusts a setting of an optical system with reference to a rotation of said rotary member in the second angle range;
a stopper which stops said power source when the rotation angle of said rotary member is decreased to a second specific angle belonging to the first angle range;
a notifier which intermittently generates a notification in a partial period during which the rotation angle of said rotary member remains within the first angle range, among periods from an activation by said activator to a stop by said stopper; and
a power-source controller which stops/restarts said power source corresponding to suspending/restarting the notification generated by said notifier.

11. An optical device according to claim 10, wherein said notifier includes a command issuer which issues a power-off command at every time a notification time period reaches a threshold value and a time setter which sets a restart time in association with an issuing process of said command issuer, and said power-source controller includes a stop controller which stops said power source in response to the power-off command issued by said command issuer, and an activation controller which activates said power source in response to an arrival of the restart time set by said time setter.

12. An optical device according to claim 10, wherein said notifier includes a first notifier which intermittently generates a first notification in a period during which the rotation angle of said rotary member remains within the first angle range without reaching the second angle range, and a second notifier which intermittently generates a second notification in a period during which the rotation angle of said rotary member remains within the first angle range without reaching the second specific angle after transitioning from the second angle range to the first angle range.

13. An optical device according to claim 10, wherein the second specific angle is equivalent to an angle narrower than the first specific angle.

14. An optical device according to claim 10, further comprising:
a processor which processes electronic data based on output of said optical system; and
an initializer which initializes a setting of said processor in association with the process of said activator.

15. An optical device according to claim 10, further comprising an imager which outputs an electronic image representing a scene captured on an imaging surface, wherein said optical system includes a zoom lens arranged on a front of said imaging surface, and said adjuster includes a zoom adjusting unit which adjusts a position of said zoom lens in accordance with the rotation of said rotary member.

16. An operation control program recorded on a non-transitory recording medium in order to control an optical device provided with a rotary member which is rotated across a first angle range and a second angle range lined up in a direction in which an angle is increased and an adjuster which adjusts a setting of an optical system with reference to a rotation of said rotary member in the second angle range, the program causing a processor of the optical device to perform the steps comprising:
an activating step of activating a power source when a rotation angle of said rotary member is increased to a first specific angle belonging to the first angle range;
a stopping step of stopping said power source when the rotation angle of said rotary member is decreased to a second specific angle belonging to the first angle range;
a notifying step of intermittently generating a notification in a partial period during which the rotation angle of said rotary member remains within the first angle range, among periods from an activation by said activating step to a stop by said stopping step; and
a power-source controlling step of stopping/restarting said power source corresponding to suspending/restarting the notification generated by said notifying step.

17. An operation control method executed by an optical device provided with a rotary member which is rotated across a first angle range and a second angle range lined up in a direction in which an angle is increased and an adjuster which adjusts a setting of an optical system with reference to a rotation of said rotary member in the second angle range, comprising:
an activating step of activating a power source when a rotation angle of said rotary member is increased to a first specific angle belonging to the first angle range;
a stopping step of stopping said power source when the rotation angle of said rotary member is decreased to a second specific angle belonging to the first angle range;
a notifying step of intermittently generating a notification in a partial period during which the rotation angle of said rotary member remains within the first angle range, among periods from an activation by said activating step to a stop by said stopping step; and
a power-source controlling step of stopping/restarting said power source corresponding to suspending/restarting the notification generated by said notifying step.
